(19) United States
(12) Patent Application Publication
(10) Pub. No.: US 2010/0324708 A1
(43) Pub. Date: Dec. 23, 2010

(54) ENCODER

(75) Inventor: Juha Petteri Ojanpera, Nokia (FI)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/744,899

(22) PCT Filed: Nov. 27, 2007
(86) PCT No.: PCT/EP07/62910

§ 371 Date: Aug. 5, 2010

(51) Int. Cl. G06F 17/00

(52) U.S. Cl. 700/94

(57) ABSTRACT

An encoder for encoding an audio signal comprising at least two channels; the encoder being configured to generate an audio difference signal dependent on at least two channels of the audio signal, wherein the audio difference signal comprises at least two parts, encode at least one part of the audio difference signal to produce a second audio difference signal and generate at least one indicator, wherein each indicator identifies the at least one part of the audio difference signal.

### FIELD OF THE INVENTION

The present invention relates to coding, and in particular, but not exclusively to speech or audio coding.

### BACKGROUND OF THE INVENTION

Audio signals, like speech or music, are encoded for example for enabling an efficient transmission or storage of the audio signals.

Audio encoders and decoders are used to represent audio based signals, such as music and background noise. These types of coders typically do not utilise a speech model for the coding process, rather they use processes for representing all types of audio signals, including speech.

Speech encoders and decoders (codecs) are usually optimised for speech signals, and can operate at either a fixed or variable bit rate.

An audio codec can also be configured to operate with varying bit rates. At lower bit rates, such an audio codec may work with speech signals at a coding rate equivalent to a pure speech codec. At higher bit rates, the audio codec may code any signal including music, background noise and speech, with higher quality and performance.

In some audio codecs the input signal is divided into a limited number of bands. Each of the band signals may be quantized. From the theory of psychoacoustics it is known that the highest frequencies in the spectrum are perceptually less important than the low frequencies. This in some audio codecs is reflected by a bit allocation where fewer bits are allocated to high frequency signals than low frequency signals.

The original audio signal which is to be processed can be a mono audio signal or a multichannel audio signal containing at least a first and a second channel signal. An example of a multichannel audio signal is a stereo audio signal, which is composed of a left channel signal and a right channel signal.

Depending on the allowed bit rate, different encoding schemes can be applied to a stereo audio signal, whereby the left and right channel signals can be encoded independently from each other. Frequently a correlation exists between the left and the right channel signals, and this is typically exploited by more advanced audio coding schemes in order to further reduce the bit rate.

Bit rates can also be reduced by utilising a low bit rate stereo extension scheme. In this type of scheme, the stereo signal is encoded as a higher bit rate mono signal which is typically accompanied with additional side information conveying the stereo extension. At the decoder the stereo audio signal is reconstructed from a combination of the high bit rate mono signal and the stereo extension side information. The side information is typically encoded at a fraction of the rate of the mono signal.

Stereo extension schemes, therefore, typically operate at coding rates in the order of just a few kbps.

However, it is not possible to reproduce an exact replica of the stereo image at the decoder with the decoder seeking to achieve a good perceptual replication of the original stereo audio signal.

The most commonly used techniques for reducing the bit rate of stereo and multichannel audio signals audio are the Mid/Side (M/S) stereo and Intensity Stereo (IS) coding schemes. Mid/Side coding, as described for example by J. D. Johnston and A. J. Ferreira in “Sum-difference stereo transform coding”, ICASSP-92 Conference Record, 1992, pp. 569-572, is used to reduce the redundancy between pairs of channels. In M/S, the left and right channel signals are transformed into sum and difference signals. Maximum coding efficiency is achieved by performing this transformation in both a frequency and time dependent manner. M/S stereo is very effective for high quality, high bit rate stereophonic coding.

In the attempt to achieve lower bit rates, IS has been used in conjunction with M/S coding, where IS constitutes a stereo extension scheme. IS coding is described in U.S. Pat. No. 5,539,829 and U.S. Pat. No. 5,606,618 whereby a portion of the spectrum is coded in mono mode, and this together with additional scaling factors for left and right channels is used to reconstruct the stereo audio signal at the decoder.

The scheme as used by IS can be considered to be part of a more general approach to coding multichannel audio signals known as spatial audio coding. Spatial audio coding transmits compressed spatial side information in addition to a basic audio signal. The side information captures the most salient perceptual aspects of the multi-channel sound image, including level differences, time/phase differences and inter-channel correlation/coherence cues. Binaural Cue Coding (BCC), as disclosed by C. Faller and F. Baumgarte “Binaural Cue Coding a Novel and Efficient Representation of Spatial Audio”, in ICASSP-92 Conference Record, 2002, pp. 1841-1844 represents a particular approach to spatial audio coding. In this approach several input audio signal channels are combined into a single “sum” signal, typically by means of down mixing process. Concurrently, the most important inter-channel cues describing the multi-channel sound image are extracted from the input channels and coded as BCC side information. At the decoder, the multi-channel output signal is generated by re-synthesising the sum signal with the inter-channel cue information.

These methods have been found to reproduce multichannel audio at a high quality using a relatively low amount of side information, for example a surround sound 5.1 channel arrangement may use 16 kbit/s for side information. However, these types of systems typically require considerable computer processing power in order to implement them, even for simple channel arrangements such as a stereo configuration.

### SUMMARY OF THE INVENTION

This invention proceeds from the consideration that whilst BCC produces high quality multi channel audio for side information utilising a relatively little overhead, it is not always possible to deploy such an algorithm which requires relatively high levels of processing power. In some circumstances it is desirable to employ algorithms which use less processing power while maintaining a level of perceptual audio quality.

Embodiments of the present invention aim to address the above problem.

There is provided according to a first aspect of the present invention an encoder for encoding an audio signal comprising at least two channels; the encoder being configured to: generate an audio difference signal dependent on at least two channels of the audio signal, wherein the audio difference signal comprises at least two parts; encode at least one part of the audio difference signal to produce a second audio difference signal; generate at least one indicator, wherein each indicator identifies the at least one part of the audio difference signal.

The encoder is preferably configured to calculate an energy value for each one of the parts of the audio difference signal.

The encoder for encoding the audio signal may be further configured to select the at least one part of the audio difference signal dependent on the energy value for each one of the parts for the audio difference signal.

The encoder for encoding the audio signal may be further configured to select the at least one part of the audio difference signal dependent on the energy value for each one of the parts for the audio difference signal.

Each part of the audio difference signal may comprise at least one spectral coefficient value.

The encoder for encoding the audio signal may further be configured to: select at least one currently unencoded part of the difference signal; encode the selected at least one currently unencoded part of the difference signal to generate a third audio difference signal; generate at least one further indicator, wherein each further indicator identifies the at least one selected unencoded part.

The encoder for encoding the audio signal may further be configured to generate the at least one further indicator dependent on the at least one indicator.

The at least one indicator may comprise at least one indicator bit associated with an index value of the at least one part of the audio difference signal, wherein each indicator bit may have a first value when the at least one part of the audio difference signal is encoded to produce a second difference signal, and a second value when the at least one part of the audio difference signal is not encoded to produce a second difference signal.

The at least one further indicator may comprise at least one further indicator bit associated with the index value of the at least one part of the difference signal, wherein each further indicator bit may have a first value when the at least one part of the audio difference signal is encoded to produce a third difference signal, and a second value when the at least one part of the audio difference signal is not encoded to produce a third difference signal.

The encoder may further be configured to remove any further indicator bits associated with any parts when the at least one part of the audio difference signal is encoded to produce a second difference signal.

The encoder for encoding the audio signal may further be configured to differentially generate at least one of the at least one indicator and the at least one further indicator.

The encoder for encoding an audio signal may further be configured to select the at least one part of the audio difference signal dependent on at least one frequency value associated with the audio difference signal part.

The encoder for encoding the audio signal may further be configured to select the at least one part of the audio difference signal having at least one frequency value less than a predefined frequency value.

The predefined frequency value is preferably 775 Hz.

The encoder for encoding the audio signal may further be configured to: select at least one part of the difference signal dependent on at least one frequency value associated with the audio difference signal part; encode the selected at least one part of the difference signal dependent on at least one frequency value associated with the audio difference signal part to generate a fourth audio difference signal.

The encoder for encoding the audio signal may further be configured to: encode the selected at least one part of the difference signal dependent on at least one frequency value associated with the audio difference signal part and to encode at least one part of the audio difference signal to produce a second audio difference signal in a first encoder; and encode the selected at least one currently unencoded part of the difference signal to generate a third audio difference signal.

According to a second aspect of the invention there is provided a decoder for decoding an encoded audio signal, configured to: receive an encoded signal comprising a difference signal part and an difference signal selection part; decode from the difference signal part dependent on the difference signal selection part at least one difference signal component; and generate at least two channels of audio signals dependent on the at least one difference signal component.

The difference signal selection part may comprise a first difference signal selection section and a second difference signal selection section, and the decoder may be configured to: decode from the difference signal part dependent on the first difference signal selection section a first part of the at least one difference signal component; and decode from the difference signal part dependent on the second difference signal selection section a second part of the at least one difference signal component.

The encoded signal may further comprise a frequency limited difference signal part and the decoder may be further configured to decode from the frequency limited difference signal part at least one further difference signal component.

The encoded signal may further comprise a single channel signal part, and the decoder is preferably further configured to: decode the single channel signal part to produce at least one single channel signal component, and generate at least one component of the first channel of the at least two channels of audio signals by summing the at least one difference signal component with the at least one single channel signal component.

According to a third aspect of the invention there is provided a method for encoding an audio signal comprising at least two channels comprising: generating an audio difference signal dependent on at least two channels of the audio signal, wherein the audio difference signal comprises at least two parts; encoding at least one part of the audio difference signal to produce a second audio difference signal; generating at least one indicator, wherein each indicator identifies the at least one part of the audio difference signal.

The method for encoding the audio signal may further comprise calculating an energy value for each one of the parts of the audio difference signal.

The method for encoding the audio signal may further comprise selecting the at least one part of the audio difference signal dependent on the energy value for each one of the parts for the audio difference signal.

Each part of the audio difference signal may comprise at least one spectral coefficient value.

The method for encoding the audio signal may further comprise: selecting at least one currently unencoded part of the difference signal; encoding the selected at feast one currently unencoded part of the difference signal to generate a third audio difference signal; generating at least one further indicator, wherein each further indicator identifies the at least one selected unencoded part.

The method for encoding the audio signal may further comprise generating the at least one further indicator dependent on the at least one indicator.

The at least one indicator may comprise at least one indicator bit associated with an index value of the at least one part of the audio difference signal, wherein each indicator bit may have a first value when the at least one part of the audio difference signal is encoded to produce a second difference signal, and a second value when the at least one part of the audio difference signal is not encoded to produce a second difference signal.

The at least one further indicator may comprise at least one further indicator bit associated with the index value of the at least one part of the difference signal, wherein each further indicator bit may have a first value when the at least one part of the audio difference signal is encoded to produce a third difference signal, and a second value when the at least one part of the audio difference signal is not encoded to produce a third difference signal.

The method for encoding the audio signal may further comprise removing any further indicator bits associated with any parts when the at least one part of the audio difference signal is encoded to produce a second difference signal.

The method for encoding the audio signal may further comprise differentially generating at least one of the at least one indicator and the at least one further indicator.

The method for encoding an audio signal may further comprise selecting the at least one part of the audio difference signal dependent on at least one frequency value associated with the audio difference signal part.

The method may further comprise selecting the at least one part of the audio difference signal having at least one frequency value less than a predefined frequency value.

The predefined frequency value is preferably 775 Hz.

The method for encoding the audio signal may further comprise: selecting at least one part of the difference signal dependent on at least one frequency value associated with the audio difference signal part; and encoding the selected at least one part of the difference signal dependent on at least one frequency value associated with the audio difference signal part to generate a fourth audio difference signal.

The method for encoding the audio signal may further comprise: encoding the selected at least one part of the difference signal dependent on at least one frequency value associated with the audio difference signal part and to encode at least one part of the audio difference signal to produce a second audio difference signal in a first encoder; and encoding the selected at least one currently unencoded part of the difference signal to generate a third audio difference signal.

According to a fourth aspect of the present invention there is provided a method for decoding an encoded audio signal, comprising: receiving an encoded signal comprising a difference signal part and an difference signal selection part; decoding from the difference signal part dependent on the difference signal selection part at least one difference signal component; and generating at least two channels of audio signals dependent on the at least one difference signal component.

The difference signal selection part may comprise a first difference signal selection section and a second difference signal selection section, the method may further comprise: decoding from the difference signal part dependent on the first difference signal selection section a first part of the at least one difference signal component; and decoding from the difference signal part dependent on the second difference signal selection section a second part of the at least one difference signal component.

The encoded signal may further comprise a frequency limited difference signal part and the method may further comprise: decoding from the frequency limited difference signal part at least one further difference signal component.

The encoded signal may further comprise a single channel signal part, and the method may further comprise: decoding the single channel signal part to produce at least one single channel signal component, and generating at least one component of the first channel of the at least two channels of audio signals by summing the at least one difference signal component with the at least one single channel signal component.

An apparatus may comprise an encoder as featured above.

An apparatus may comprise a decoder as featured above.

An electronic device may comprise an encoder as featured above.

An electronic device may comprise a decoder as featured above.

A chipset may comprise an encoder as featured above.

A chipset may comprise a decoder as featured above.

According to a fifth aspect of the present invention there is provided a computer program product configured to perform a method for encoding an audio signal comprising at least two channels comprising: generating an audio difference signal dependent on at least two channels of the audio signal, wherein the audio difference signal comprises at least two parts; encoding at least one part of the audio difference signal to produce a second audio difference signal; and generating at least one indicator, wherein each indicator identifies the at least one part of the audio difference signal.

According to a sixth aspect of the present invention there is provided a computer program product configured to perform a method for decoding an encoded audio signal, comprising: receiving an encoded signal comprising a difference signal part and an difference signal selection part; decoding from the difference signal part dependent on the difference signal selection part at least one difference signal component; and generating at least two channels of audio signals dependent on the at least one difference signal component.

According to a seventh aspect of the present invention there is provided an encoder for encoding an audio signal comprising at least two channels; comprising: a first signal processor configured to generate an audio difference signal dependent on at least two channels of the audio signal, wherein the audio difference signal comprises at least two parts; a second signal processor configured to encode at least one part of the audio difference signal to produce a second audio difference signal; a third signal processor configured to generate at least one indicator, wherein each indicator identifies the at least one part of the audio difference signal.

According to an eighth aspect of the present invention there is provided a decoder for decoding an encoded audio signal, comprising: receive means for receiving an encoded signal comprising a difference signal part and an difference signal selection part; processing means for decoding from the difference signal part dependent on the difference signal selection part at least one difference signal component; and further processing means for generating at least two channels of audio signals dependent on the at least one difference signal component.

### BRIEF DESCRIPTION OF DRAWINGS

For better understanding of the present invention, reference will now be made by way of example to the accompanying drawings in which:

FIG. 1 shows schematically an electronic device employing embodiments of the invention;

FIG. 2 shows schematically an audio codec system employing embodiments of the present invention;

FIG. 3 shows schematically an encoder part of the audio codec system shown in FIG. 2;

FIG. 4 shows schematically a region encoder part of the audio codec system shown in FIG. 3;

FIG. 5 shows a flow diagram illustrating the operation of an embodiment of the audio encoder as shown in FIG. 3 according to the present invention;

FIG. 6 shows a flow diagram illustrating in further detail the operation of a part of the audio encoder as shown in FIG. 5 according to the present invention;

FIG. 7 shows a schematically an decoder part of the audio codec system shown in FIG. 2; and

FIG. 8 shows a flow diagram illustrating the operation of an embodiment of the audio decoder as shown in FIG. 7 according to the present invention;

FIG. 9 shows a flow diagram illustrating in further detail the operation of a part of the operation of the audio encoder as shown in FIG. 6 embodiment of the region encoder as shown in FIG. 4 according to the present invention.

### DESCRIPTION OF PREFERRED EMBODIMENTS OF THE INVENTION

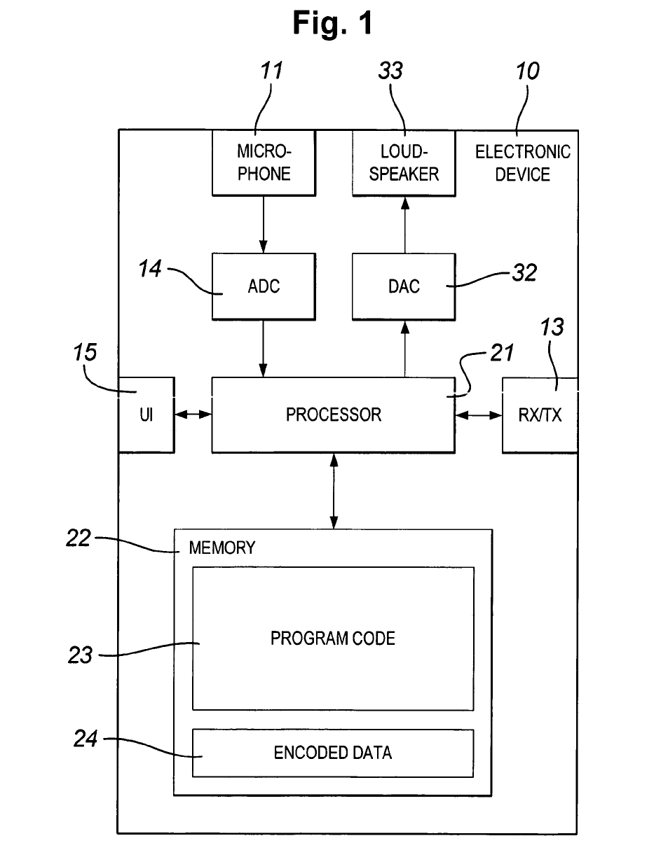

The following describes in more detail possible mechanisms for the provision of a low complexity multichannel audio coding system. In this regard reference is first made to FIG. 1 schematic block diagram of an exemplary electronic device 10, which may incorporate a codec according to an embodiment of the invention.

The electronic device 10 may for example be a mobile terminal or user equipment of a wireless communication system.

The electronic device 10 comprises a microphone 11, which is linked via an analogue-to-digital converter 14 to a processor 21. The processor 21 is further linked via a digital-to-analogue converter 32 to loudspeakers 33. The processor 21 is further linked to a transceiver (TX/RX) 13, to a user interface (UI) 15 and to a memory 22.

The processor 21 may be configured to execute various program codes. The implemented program codes comprise an audio encoding code for encoding a combined audio signal and code to extract and encode side information pertaining to the spatial information of the multiple channels. The implemented program codes 23 further comprise an audio decoding code. The implemented program codes 23 may be stored for example in the memory 22 for retrieval by the processor 21 whenever needed. The memory 22 could further provide a section 24 for storing data, for example data that has been encoded in accordance with the invention.

The encoding and decoding code may in embodiments of the invention be implemented in hardware or firmware.

The user interface 15 enables a user to input commands to the electronic device 10, for example via a keypad, and/or to obtain information from the electronic device 10, for example via a display. The transceiver 13 enables a communication with other electronic devices, for example via a wireless communication network.

It is to be understood again that the structure of the electronic device 10 could be supplemented and varied in many ways.

A user of the electronic device 10 may use the microphone 11 for inputting speech that is to be transmitted to some other electronic device or that is to be stored in the data section 24 of the memory 22. A corresponding application has been activated to this end by the user via the user interface 15. This application, which may be run by the processor 21, causes the processor 21 to execute the encoding code stored in the memory 22.

The analogue-to-digital converter 14 converts the input analogue audio signal into a digital audio signal and provides the digital audio signal to the processor 21.

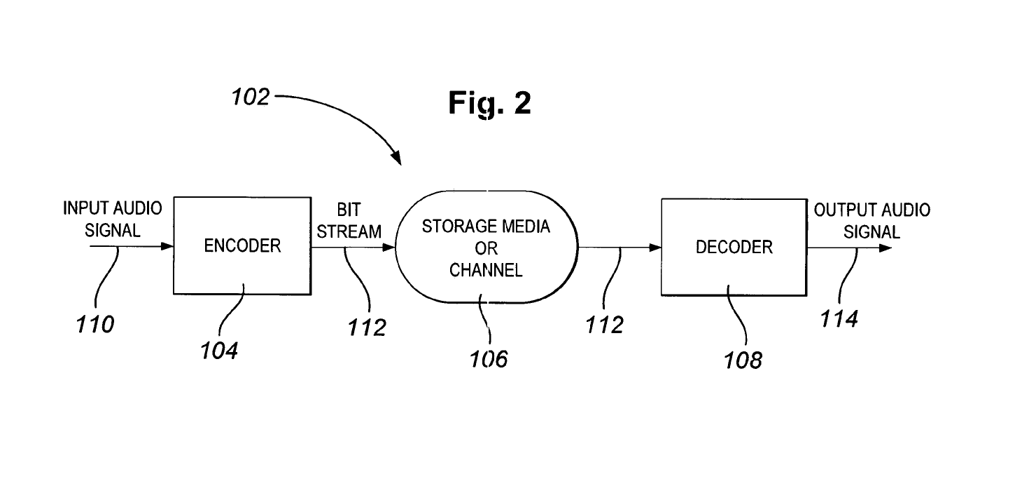

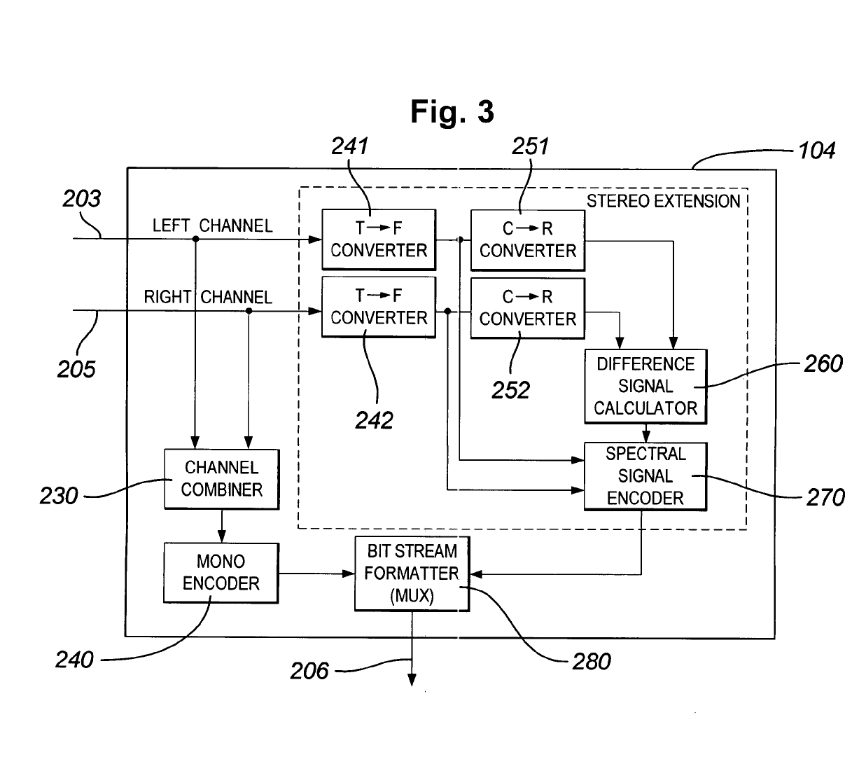

The processor 21 may then process the digital audio signal in the same way as described with reference to FIGS. 2 and 3.

The resulting bit stream is provided to the transceiver 13 for transmission to another electronic device. Alternatively, the coded data could be stored in the data section 24 of the memory 22, for instance for a later transmission or for a later presentation by the same electronic device 10.

The electronic device 10 could also receive a bit stream with correspondingly encoded data from another electronic device via its transceiver 13. In this case, the processor 21 may execute the decoding program code stored in the memory 22. The processor 21 decodes the received data, and provides the decoded data to the digital-to-analogue converter 32. The digital-to-analogue converter 32 converts the digital decoded data into analogue audio data and outputs them via the loudspeakers 33. Execution of the decoding program code could be triggered as well by an application that has been called by the user via the user interface 15.

The received encoded data could also be stored instead of an immediate presentation via the loudspeakers 33 in the data section 24 of the memory 22, for instance for enabling a later presentation or a forwarding to still another electronic device.

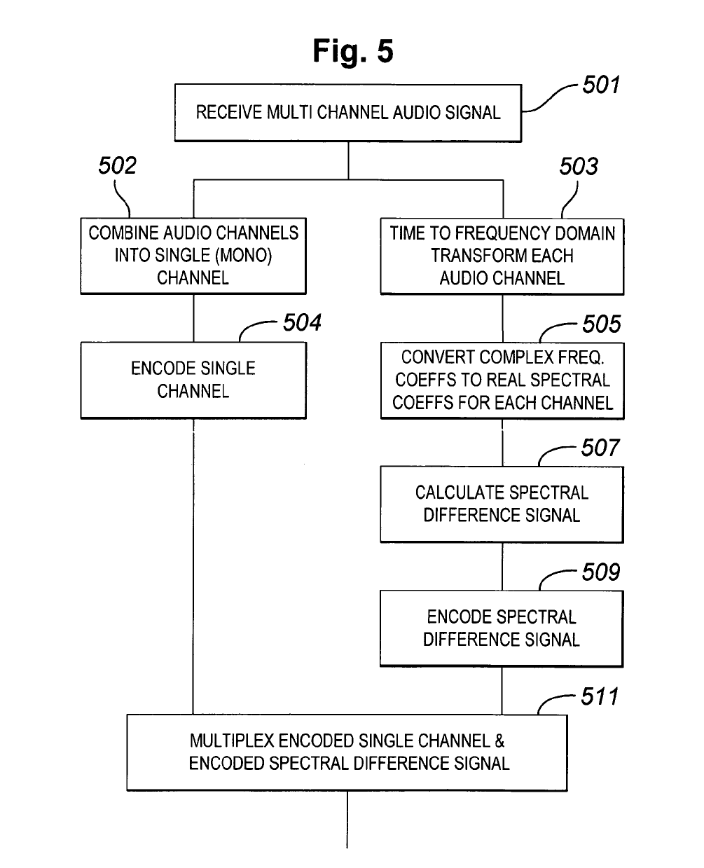

It would be appreciated that the schematic structures described in FIGS. 2, 3, 4 and 7 and the method steps in FIGS. 5, 6 and 8 represent only a part of the operation of a complete audio codec as exemplarily shown implemented in the electronic device shown in FIG. 1.

The general operation of audio codecs as employed by embodiments of the invention is shown in FIG. 2. General audio coding/decoding systems consist of an encoder and a decoder, as illustrated schematically in FIG. 2. Illustrated is a system 102 with an encoder 104, a storage or media channel 106 and a decoder 108.

The encoder 104 compresses an input audio signal 110 producing a bit stream 112, which is either stored or transmitted through a media channel 106. The bit stream 112 can be received within the decoder 108. The decoder 108 decompresses the bit stream 112 and produces an output audio signal 114. The bit rate of the bit stream 112 and the quality of the output audio signal 114 in relation to the input signal 110 are the main features, which define the performance of the coding system 102.

FIG. 3 depicts schematically an encoder 104 according to an exemplary embodiment of the invention. The encoder 104 comprises a pair of inputs 203 and 205 which are arranged to receive an audio signal comprising of two channels. The two channels 203, 205 may be arranged in embodiments of the invention as a stereo pair, in other words one channel input 203 is a left channel input and the other channel input 205 is a right channel input. It is to be understood that further embodiments of the present invention may be arranged to receive more than two input audio signal channels, for example a six channel input arrangement may be used to receive a 5.1 surround sound audio channel configuration.

The left and right channel inputs 203 and 205 are connected to a channel combiner 230, which combines the inputs into a single channel signal. The output from the channel combiner is connected to an audio encoder 240, which is arranged to encode the single channel (or mono channel) audio signal input.

The left and right channel inputs 203 and 205 are also each additionally connected to a respective left channel and right channel time domain to frequency domain transformer 241 and 242. Thus left channel input 203 is configured to be connected to the left channel time domain frequency domain transformer 241, and right channel input 205 is configured to be connected to right channel time domain to frequency domain transformer 242. The left and right channel time domain to frequency domain transformers 241, 243 are configured to output frequency domain representations of the respective input signals. The left channel time domain to frequency domain transformer 241 is configured to be connected to an input of a left channel frequency domain complex to real space converter 251. The output of the left channel frequency domain complex to real space converter 251 is configured to be connected to an input of the difference signal calculator 260.

The right channel time domain to frequency domain transformer 251 is configured to be connected to an input of a right channel frequency domain complex to real space converter 252. The output of the right channel frequency domain complex to real space converter 252 is configured to be connected to a further input of the difference signal calculator 260.

The frequency domain complex to real space converters 251 252 are configured to output modified discrete cosine spectral coefficients.

The spectral difference signal calculator 260 is configured to generate and output a single spectral difference signal from the two input frequency domain complex to real space converter outputs. The output from the spectral difference signal calculator 260 may be connected to a further input of the spectral encoder 270.

The output from the spectral encoder 270 may be connected to the input of the bitstream formatter 280 (which in some embodiments of the invention is also known as the bitstream multiplexer). Additionally, the bitstream formatter 280 may be configured to receive as a further input the encoded output from the single channel audio encoder 240. The bitstream formatter 280 may then be arranged to output the output bitstream 112 via the output 206.

The operation of these components is described in more detail with reference to the flow chart FIG. 5 showing the operation of the encoder 104.

The audio signal is received by the coder 104. In a first embodiment of the invention the audio signal is a digitally sampled signal. In other embodiments of the present invention the audio input may be an analogue audio signal, for example from a microphone 6, which is analogue to digitally (A/D) converted. In further embodiments of the invention the audio input is converted from a pulse code modulation digital signal to amplitude modulation digital signal. The receiving of the audio signal is shown in FIG. 5 by step 501.

The channel combiner 230 receives both the left channel input and right channel input from the stereo audio signal and combines them into a single (or mono) audio channel signal. In some embodiments of the present invention this may take the form of simply adding the left and the right channel samples and then dividing the sum by two. This process is typically performed on a sample by sample basis. In further embodiments of the invention, especially those which comprise more than two input channels, down mixing using matrixing techniques may be used to combine the channels. This process of combination may be performed either in the time or frequency domains.

The combining of audio channels is shown in FIG. 5 by step 502.

The audio (mono) encoder 240 receives the combined single channel audio signal and applies a suitable coding scheme upon the signal. In an embodiment of the invention the coder 240 may transform the signal into the frequency domain by the means of a suitable discrete unitary transform, of which non limiting examples may include the Discrete Fourier Transform (DCT) or the Modified Discrete Cosine Transform (MDCT). On other embodiments of the invention, the audio encoder may employ a codec which operates an analysis filterbank structure in order to generate a frequency domain based representation of the signal. Examples of the analysis filter bank structures may include but are not limited to quadrature mirror filterbank (QMF) and cosine modulated Pseudo QMF filterbanks.

The signal may in some embodiments be further grouped into sub bands and each sub band may be quantised and coded using the information provided by a psychoacoustic model. The quantisation settings as well as the coding scheme may be dictated by the applied psychoacoustic model. The quantised, coded information is sent to the bit stream formatter 280 for creating a bit stream 112.

The encoding of the single channel audio signal is shown in FIG. 5 by step 504.

In other embodiments of the invention other audio codecs may be employed in order to encode the combined single channel audio signal. Examples of these further embodiments include but are not Limited to advanced audio coding (AAC), MPEG I layer III (MP3), the ITU-T Embedded variable rate (EV-VBR) speech coding baseline codec, Adaptive Multirate Rate-Wide band (AMR-WB), and Adaptive Multirate Rate-Wideband Plus (AMR-WB+).

The left channel audio signal (in other words the signal received on the left channel input 203) is received by the left channel time domain to frequency domain transformer 241 which is configured to transform the received signal into the frequency domain represented as frequency based coefficients

Concurrently, the right channel audio signal (in other words the signal received on the right channel input 205) is received by the right channel time domain to frequency domain transformer 242 which is configured to also transform the received signal into the frequency domain represented as frequency based coefficients.

In a first embodiment of the present invention each of the left and right channel time domain to frequency domain transformers 241 and 242 are based on a variant of the discrete fourier transform (DFT). Theses variants of the DFT may be the shifted discrete fourier transform (SDFT).

In further embodiments of the present invention these time domain to frequency domain transformation stages may use other discrete orthogonal transforms, such as the discrete fourier transform (DFT), the modified discrete cosine transform (MDCT) and modified lapped transform (MLT).

The transformation of the left and right audio channels into the frequency domain is exemplary depicted by step 503, in FIG. 5.

In embodiments of the invention the outputs from each of the left and right channel time domain to frequency domain transformers 241 and 242 may be in the form of complex spectral coefficients.

The output of the left channel time domain to frequency domain transformer 241 may output the complex spectral coefficient values to the frequency domain left channel complex to real space converter 251 to convert the complex spectral coefficient values into real spectral coefficient values.

The output of the right channel time domain to frequency domain transformer 242 may output the complex spectral coefficient values to the frequency domain right channel complex to real space converter 252 to convert the complex spectral coefficient values into real spectral coefficient values.

In a first embodiment of the invention each of the left and right channel complex to real space converters 251 252 may generate a modified discrete cosine transform value from the shifted discrete fourier transform values. In an embodiment of the invention the modified discrete cosine transform coefficients are formed by multiplying the real component for each SOFT coefficient by two. This step may be represented as

F_{L}(i)=2·f_{L}_{ᵣₑₐₗ}(i), 0≦i<N

F_{R}(i)=2·f_{R}_{ᵣₑₐₗ}(i)

where f_{L} and f_{R} are the complex valued SOFT samples for the left and right channels, respectively, and N is the size of the frame.

In some embodiments of the invention the conversion of the complex spectral coefficients into real spectral coefficients may be carried out as part of the time domain to frequency domain transformation process.

Furthermore as indicated previously in other embodiments each of the complex to real space converters are optional. For example, there may be no complex to real space converters, or the converters may be bypassed in embodiments of the invention which use time domain to frequency domain transformations which output real space spectral coefficients.

The process of converting the complex spectral coefficients into real spectral coefficients is shown as step 505 in FIG. 5.

The spectral difference signal calculator 260 receives the left and right channel real spectral coefficients from the left and right channel frequency domain complex to real space converters 251 and 252.

The spectral difference signal calculator 260 processes the real spectral coefficients for each channel on a frame by frame basis in order to determine a single spectral difference signal.

In a first embodiment of the invention the spectral difference signal may be formed by taking the difference between the real spectral coefficient for a first channel signal from the real spectral coefficient for a second channel signal for each spectral coefficient index. This step may be represented as

D_{f}(i)=(F_{L}(i)−F_{R}(i))·0.5, 0≦i<N

where F_{L} and F_{R} are the real coefficients for the first and second channels respectively (in other words they may be the real coefficients for a stereo channel pair comprising of a left and a right channel), and D_{f} is the spectral difference signal. In this embodiment of the invention the sum channel (sum=(L+R)/2) is encoded separately with a different coding scheme, for example with EV-VBR codec and the difference as described above. The scaling is used to align the amplitude levels when the sum and difference channels are combined back to left (L=sum+D) and right (R=sum−D) channels. However in further embodiments of the invention the scaling factor is not necessary and the difference may be used without the scaling factor.

The process of calculating the spectral difference signal is shown as step 507 in FIG. 5.

The output of the spectral difference signal calculator 260 may be connected to the spectral difference signal encoder 270. Additionally, the left and right channel spectral coefficient values output from the left and right channel time domain to frequency domain transformers 241 and 242 respectively may also be connected to the spectral difference signal encoder 270 as further inputs.

In an exemplary embodiment of the invention the spectral difference signal encoder 270 processes the spectral coefficients associated with the spectral difference signal in order to determine sub band ordering information and an associated quantized coefficient value on a per sub band basis.

This process of determining the sub band ordering information and associated quantized coefficient value is shown by step 509 in FIG. 5.

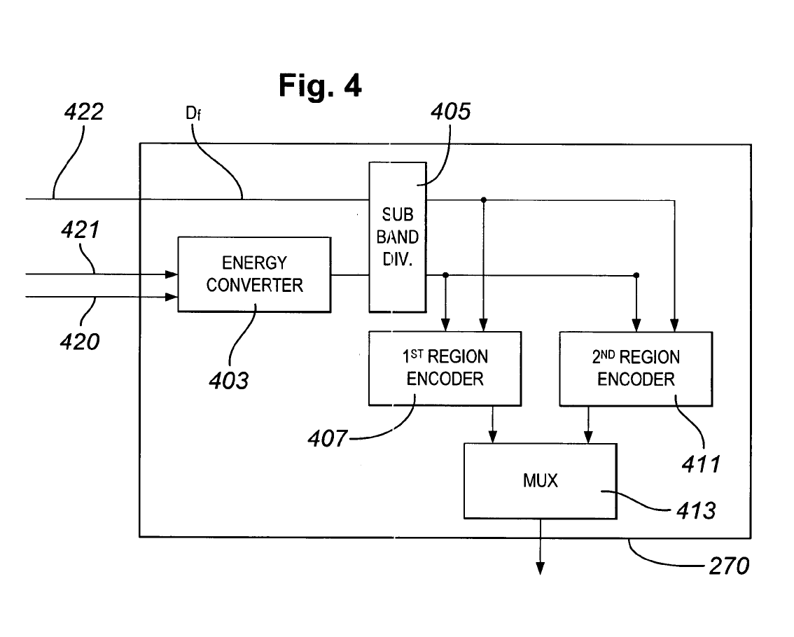

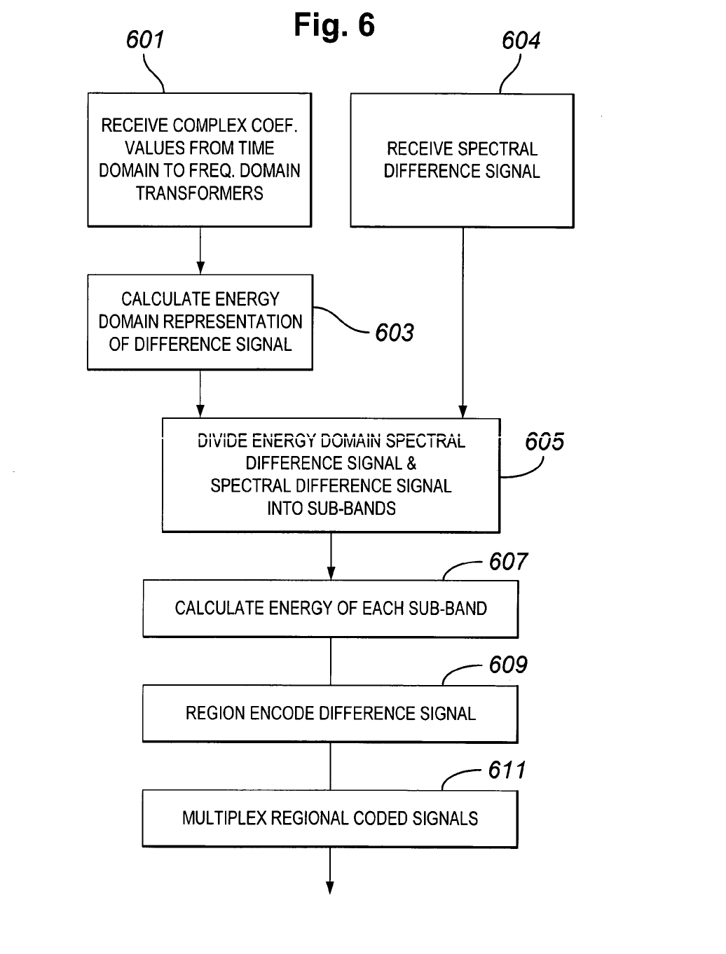

FIG. 4 schematically depicts in further detail the spectral difference signal encoder 270 shown in FIG. 3. The operation of the spectral difference signal encoder will hereafter be described in more detail in conjunction with the flow chart of FIG. 6.

The spectral difference signal encoder 270 comprises a left channel input 421, and a right channel input 420. The left channel input 421 and right channel input 420 are configured to be connected to a left and right channel input of an energy converter 403. The energy converter 403 is further configured to be connected to an input of a sub-band divider 405. The difference channel input 422 is configured to be connected to a further input to the sub-band divider 405. The sub-band divider is configured to be connected to an input of a 1st region encoder 407 and an input of a 2nd region encoder 411. The sub-band divider is also configured to have a second output connected to a further input of the 1st region encoder 407 and a further input of the 2nd region encoder. The 1st region encoder is configured to have an output connected to a first input of a multiplexer 413. The 2nd region encoder is configured to have an output connected to a further input of the multiplexer 413.

The energy converter 403 may receive the complex spectral coefficients from the left and right channel time domain to frequency domain transformers 241 and 242 via the left channel input 420 and right channel input 421 respectively.

The receiving the complex spectral coefficients from each of the time domain to frequency domain transformers is shown as step 601 in FIG. 6.

The energy converter 403 may then calculate an energy domain representation for the spectral difference signal from the received complex spectral coefficients.

In a first embodiment of the invention the energy domain representation of the spectral difference signal may be determined by first calculating the real spectral difference signal for each spectral coefficient index, secondly calculating the imaginary spectral difference signal for each spectral coefficient, and finally calculating the magnitude of the complex difference signal for each index by taking the square root of the sum of the squares of the real and imaginary components for each spectral coefficient index. This process may be expressed according to the following equations:

E_{D}(i)={square root over (E_{D}_{ᵣₑₐₗ}(i)²+E_{D}_{_{imag}}(i)²)}, 0≦i<N

Dᵣₑₐₗ(i)=(f_{L}_{ᵣₑₐₗ}(i)−f_{R}_{ᵣₑₐₗ}(i))·0.5

D_{imag}(i)=(f_{L}_{_{imag}}(i)−f_{R}_{_{imag}}(i))·0.5

where f_{L}_{ᵣₑₐₗ} and f_{L}_{_{imag}} are the real and imaginary components of the SDFT coefficient values for the left channel, f_{R}_{ᵣₑₐₗ} and f_{R}_{_{imag}} are the real and imaginary components of the SDFT coefficient values for the right channel, Dᵣₑₐₗ and D_{imag} are the real and imaginary components of the spectral difference signal, E_{D} is the energy domain representation of the spectral difference signal, and N is the size of the frame.

It is to be understood that in further embodiments of invention the energy converter 403 may receive real space representations of the spectral coefficient values only. In the real space spectral coefficient value embodiments the energy domain representation of the difference signal may be generated from the square of the coefficients of the difference signal for each coefficient index.

The calculating the energy domain representation of the difference signal is shown as step 603 in FIG. 6.

As described previously the output of the spectral energy converter 403 may be connected to the input of the sub band divider 405. Additionally the spectral difference signal received from the difference channel input 422 may also be connected to a further input of the sub band divider 405.

The receiving the coefficients of the spectral difference signal via the input 422 is shown as step 604 in FIG. 6.

The sub band divider 405 may divide both the spectral difference signal and energy domain difference signal into a number of sub bands. Each sub band may contain a number of frequency (or spectral) coefficients and the distribution of frequency coefficients to each sub band may be determined according to psychoacoustic principles.

In some embodiments of the invention the whole spectrum of the signal may be divided into sub bands.

In further embodiments of the invention a part of the signal spectrum may be divided into sub bands, and the remaining coefficients discarded. Such embodiments may be used when only a portion of the whole bandwidth of the spectral difference signal is encoded. Typically in such partially encoded bandwidth embodiments the coefficients associated with the higher frequencies may be discarded.

The dividing the spectral difference and the energy domain spectral difference signals into sub bands is shown as step 605 in FIG. 6.

Additionally, the sub band divider 405 may comprise a further processing stage which determines the energy level for each sub band. This may be done by summing for each sub band the spectral coefficient energy values calculated by the energy converter. This for example may be represented according to the following equation:

$${e}_{D} ( i ) = {\sum }_{j = {offset}_{1} [ i ]}^{{offset}_{1} [ i + 1 ] - 1} {E}_{D} ( j ) , 0 \leq i < M$$

where offset₁ is the frequency offset table describing the frequency index offsets for each spectral sub band, and M is the number of spectral sub bands present in the frame.

For example, according to an exemplary embodiment of the invention an audio signal whose sampling rate is 32 kHz with a frame size of 20 ms may comprise 640 frequency spectral coefficients. The spectral difference signal and the energy domain difference signal may be divided into a number of sub bands where the number of frequency coefficients distributed to each sub band may be aligned to the boundaries of the critical bands of the human hearing system.

Thus in embodiments of the invention a series of offset values, which identify when the end of a sub-band has been reached with regards to the spectral coefficient index, may be defined. One embodiment of the invention may define the offset values for the sub-bands and regions using the above region and frame variables as follows:

offset₁=0, 4, 8, 12, 16, 20, 25, 31, 37, 43, 51, 59, 69, 80, 93, 108, 126, 148, 176, 212, 256]

It is to be noted that in this example spectral coefficients over the frequency range from 0 Hz to 6400 Hz are divided into sub bands. The spectral coefficients associated with frequencies higher than 6400 Hz are discarded.

The optional operation of calculating the energy level for each sub band is shown as step 607 in FIG. 6.

The spectral signal encoder 270 may then encode the spectral difference signal according to the characteristics of the signal spectral coefficients. This may take the form of region based encoding, where an encoder may be tailored to encode characteristic features which are present within different regions of the signal.

In some embodiments of the invention, region based encoding may be effectuated by dividing the total spectrum of the difference signal into various regions, where each region may represent a range of frequencies as represented by the respective spectral coefficients. The division of the spectral difference signal into regions may take the form of either grouping spectral coefficients, or grouping sub bands. The region encoder may then be optimally tuned to encode particular signal characteristics within the region.

In further embodiments of the invention the frequency ranges of each region may overlap with neighbouring regions.

Furthermore within embodiments of the invention the sub-band divider may divide the spectral difference signal into sub regions based upon the relative importance of frequency components within the spectrum.

Further still, region based encoding as implemented by embodiments of the invention may be dependent on the available coding bandwidth. In such embodiments the spectrum of the difference signal may be divided into different sub regions according to the allocation of coding bits on a per sub region basis.

It is to be understood that embodiments of the invention may divide spectrum of the difference signal into different regions according to a combination of the above.

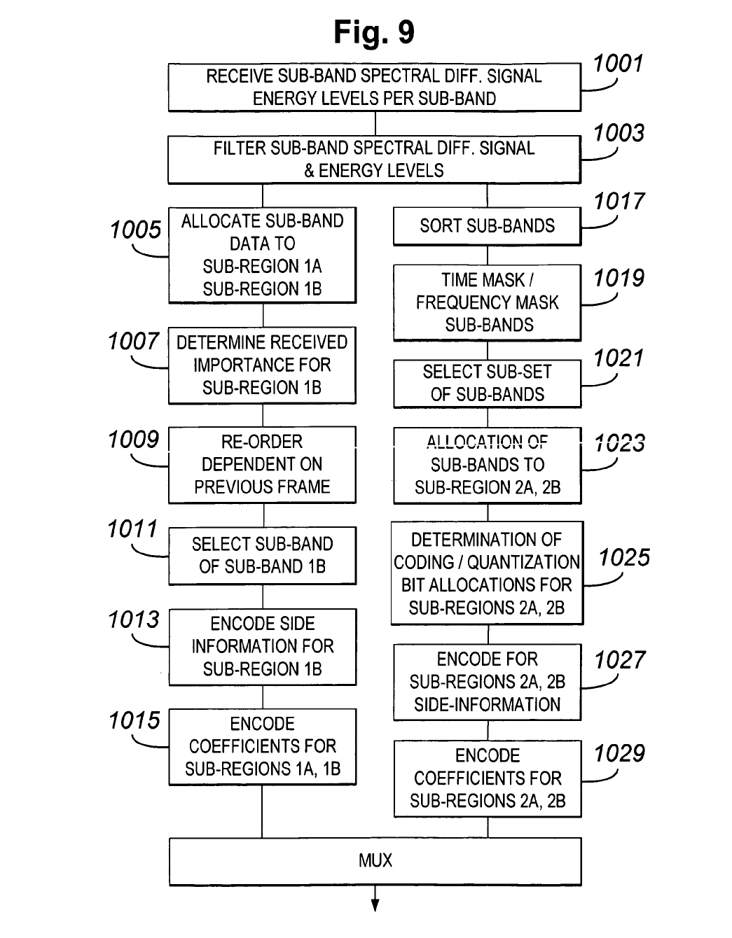

The regional encoding procedure is described hereafter as being carried out by a first region encoder 407 and a second region encoder 411. The operation of the first region encoder 407 and second region encoder 411 will hereafter be described in more detail in conjunction with the flow chart of FIG. 9.

In a preferred embodiment of the present invention the outputs from the sub band divider 405, comprise the sub band divided spectral difference signal and energy levels for each sub band, and are input to the first region encoder 407 and the second region encoder 411.

The process of receiving the sub band divided spectral difference signal and energy levels for each sub band is shown as step 1001 in FIG. 9.

Furthermore the dividing the total spectrum of the difference signal into various regions, where each region may represent a range of frequencies as represented by the respective spectral coefficients, as described above may be carried out by the 1st region encoder 407 discarding or filtering out the spectral coefficients associated with the higher frequencies, similarly the 2nd region encoder 411 may discard or filter out the spectral coefficients associated with the lower frequencies. As disclosed previously the filtering may mean that some difference coefficients are passed to more than one region encoder.

In some embodiments of the invention the sub-band divider 405 may carry out the filtering process.

The operation of filtering the sub-band spectral difference signal and energy levels per sub-band is shown in FIG. 9 by step 1003.

The first region encoder 407 may encode the signal based on at least one of the following criteria; spectral frequency range of the difference signal, relative importance of frequency components within the spectral range, and available coding bandwidth.

For example in a first embodiment of the invention the first region encoder 407 is configured to encode the difference signal over a spectral range (in other words the audio bandwidth) of the input sub band divided spectral difference signal which as described above is limited to the lower frequencies only.

In some embodiments of the invention the 1st region encoder 407 may be configured to use a feedback path from the first region encoder 407 to a further input to the sub band divider 405 to convey information back to the sub band divider about which sub bands have not been encoded by the first region encoder 407.

In a preferred embodiment of the invention the first region encoder 407 may further divide the received spectral difference signal into at least two further sub regions. In a first embodiment of the invention these sub regions are designated sub-region 1A and sub-region 1B.

The first sub region (sub-region 1A) may consist of the lower frequencies of the 1st region spectral difference signal and associated energy level. The first sub-region may be associated with the lower frequencies of the audio signal and may be deemed to have a higher perceptual importance than higher frequencies.

The first region encoder 407 may furthermore allocate to the first sub region a fixed number of spectral coefficients or sub bands for each audio frame. This fixed number of spectral coefficients may be encoded, as will be described later, at a fixed bit rate.

The second sub region (region 1 B) determined by the first region encoder 407 may consist of the higher frequency components present in the first region allocated signal and may be deemed as to have a lower perceptual importance. The first region encoder 407 may furthermore, as will be described later, encode the second sub region using less coding bits than the number of bits assigned to encode the first (and lower frequency) sub-region.

The number of sub bands which may be encoded within the second sub region may be determined by the relative importance of each sub band and the coding bandwidth availability.

In some embodiments of the invention the number of selected sub bands which are encoded within the second sub region may vary from one audio frame to the next.

It is to be understood that within the first region encoder 407 a measure of perceptual importance may be associated with each sub band dependent on the sub-band energy level, as determined in optional arrangements of the sub band divider 405.

The first region encoder 407 may allocate the number of bits to be used to encode the second sub region dependent on the difference between the total amount of bits allocated to the first region encoder 407 and the total number of bits required to encode the first sub region.

According to a preferred embodiment of the invention this may be expressed as

$$vBits = ( coreBits - fixed\_part \_size \cdot 2 ) / 2.5$$

$$fixed\_part \_size = {\sum }_{i = 0}^{fixedBands - 1} {offset}_{1} [ i ]$$

Where the parameter fixedBands represents the number of fixed sub bands in the first sub region which are encoded by the first region encoder 407. The number of fixed sub bands within the first sub region of the spectrum may be pre-determined for a particular sampling frequency of the audio signal.

For example, in an experimentally determined arrangement where the sampling frequency of the audio signal is 32 kHz, we may determine that the first sub region represents the frequency range from 0 to 775 Hz and uses a total of 7 sub bands. The parameter fixed_part_size may represent the number of bits allocated for encoding first sub region by the first region encoder. The parameter coreBits may represent the total number of bits available for encoding within the first region encoder.

In some embodiments of the invention the number of bits allocated for encoding the first sub region and the total number of bits allocated for the first region encoder may also be pre determined for a particular sampling frequency of the audio signal. As before, the allocated bits for encoding the first sub region and the total number of bits may be determined experimentally to produce an advantageous result.

It is to be understood that the number of bits allocated to encode the second sub region may in turn determine the number of spectral coefficients and hence the number of sub bands which can be encoded. The first region encoder may therefore use a mapping ratio of the number of bits available for coding to the number of spectral coefficients. The mapping ratio may further depend on the quantisation scheme adopted for the representation of the spectral coefficients

The allocation of sub-bands, and determining the number of bits available for encoding each sub region is shown as step 1005 in FIG. 9.

The 1st region encoder 407 may then determine a perceived importance ordering of the sub-bands within the second sub-region, to produce a ranking order of descending relative importance based upon the energy values of each sub band as determined by the sub band divider 405.

The determining of relative ordering of second sub-region sub-bands is shown as step 1007 in FIG. 9.

The 1st region encoder 407 may furthermore reorder the 1st region second sub-region sub-bands relative importance by incorporating additional criteria into the reordering process such as considering the order of the sub-bands out of the same sub-region from the previous frame.

For example, the 1st region encoder 407 may determine that it may be advantageous to increase the ranking of a lower rated sub-band from a current frame if the same sub-band in a previous frame had a higher rating. This re-ordering may assist in producing a smoother transition of a stereo audio scene from one frame to the next.

In a preferred embodiment of the invention, the reordering of the second sub-region sub-bands may take the form of comparing the sub-band ranking order from the current frame with the sub-band ranking order from the previous frame, and noting any sub-bands which have a relative high ranking value in the previous frame but are represented with a low ranking value in the current frame.

An identified sub-band from the current frame may then have their ranking order increased to reflect the level at which it is set in the previous frame. This process may in some embodiments be implemented as an iterative loop, whereby upon the start of the next iteration the revised ranking order of the current frame is checked against the previous frame in order to determine the next lowest ranked sub-band.

This process may be represented by the following section of pseudo code.

```
mBands = varBands − fixedBands;
for(m = 0; m < mBands / 2 − 1; m++)
{
  isFound = 0;
  for(i = 0; i <= m + 1; i++)
    isFound |= (g[i].gainIndex == prevCodedRegion1[m]) ? 1 : 0;
  if(!isFound)
  {
  for(k = 0; k < mBands; k++)
  {
    if(g[k].gainIndex == prevCodedRegion1[m])
      break;
  }
  if(k != mBands)
    SwitchPlaces(g, k, m + 1);
  }
}
for(m = 0; m < mBands; m++)
  prevCodedRegion1[m] = g[m].gainIndex;
```

Where prevCodedRegion1 is an array containing index of sub-bands from the previous frame in decreasing rank order, mbands is a parameter determining the number of bands to search over, and the SwitchPlaces routine performs the actual function of increasing the rank order of the identified sub band. The SwitchPlaces routine may be implemented in embodiments of the invention using the following pseudo-code:

```
SwitchPlaces(GainItem *g, int16 idx, int16 lowestIdx)
{
  gTmp.gainIndex = g[idx].gainIndex;
  for(k = idx; k > lowestIdx; k−−)
    g[k].gainIndex = g[k − 1].gainIndex;
  g[lowestIdx].gainIndex = gTmp.gainIndex;
}
```

The operation of this pseudo code, can be effectively summarized by the operations of read an index from the previous frame, if the index in the current frame is lower than the previous frame then promote the index to be one lower than the previous frame relative importance index. This may be further explained by way of the following example.

Let the previous frame have a sub-band ranking order of:

prevCodedRegion1: 23 11 16 13 14 15 22 21 12 17 20 18 19 18

where the numbers indicate the index of the sub band

Let the current frame sub band ranking order be:

Sub band Index: 23 17 12 20 22 21 18 19 14 11 15 16 13 10

The first gain index 23 read is the same in the present and previous frame and no switch is required.

The next gain index read 11 is lower in the present frame and a switch or promotion is made.

switching index (value): k=9 (gainIndex=11) m+1=2 (gainIndex=12)

re-ordered gainIndex after calling SwitchPlaces( ): 23 17 11 12 20 22 21 18 19 14 15 16 13 10

Similarly the next gain index read 16 is also promoted.

switching index (value): k=11 (gainIndex=16) m+1=3 (gainIndex=12)

re-ordered gainIndex: 23 17 11 16 12 20 22 21 18 19 14 15 13 10

Also the next gain index read 13 is also promoted.

switching index (value): k=12 (gainIndex=13) m+1=4 (gainIndex=12)

re-ordered gainIndex: 23 17 11 16 13 12 20 22 21 18 19 14 15 10

Furthermore the next two gain indices read 14 and 15 are also promoted.

switching index (value): k=11 (gainIndex=14) m+1=5 (gainIndex=12)

re-ordered gainIndex: 23 17 11 11 16 13 14 12 20 22 21 18 19 15 10

switching index (value): k=12 (gainIndex=15) m+1=6 (gainIndex=12)

re-ordered gainIndex: 23 17 11 16 13 14 15 12 20 22 21 18 19 10

The remainder of the gainIndex values have a higher value in the original present frame order than the previous frame and are not promoted and so the final gainIndex values are:

23 17 11 16 13 14 15 12 20 22 21 18 19 10

The reordering the second sub-region sub-bands with reference to the rank order of sub bands from a previous frame is shown as step 1009 in FIG. 9.

The first region encoder 407 then may select a sub-set of second sub-region sub-bands according to the revised rank order as determined by the output from the second sub-region re-ordering process.

The first region encoder 407 determines a number of sub-bands which may comprise this sub-set at least in part by the calculation of the number of bits available for encoding the second sub-region, as described previously. The selection process may then keep the most important sub bands and discard the rest.

The second sub-region sub-band selection process may be explained further by a continuation of the previous example. The index of the reordered sub-bands for the second sub region may be listed in decreasing rank order as

23 17 11 16 13 14 15 12 20 22 21 18 19 10

The output from the second sub region bit availability processing step, as shown above, may indicate that only 6 sub bands may be encoded and thus in accordance with the above example only the first 6 sub bands will be kept. Thus with respect to this example the first region encoder 407 selects the sub-set comprising sub-bands

23 17 11 16 13 14

The selecting the sub-set of sub-bands for encoding is shown as step 1011 in FIG. 9.

The first region encoder 407 may then encode side information for the spectral difference signal for the selected sub-set of sub-bands present in the second sub-region for transmission or storage. In a preferred embodiment of the invention this may be done by associating a signalling bit with each sub-band within the second sub-bit to indicate that the sub-band has been encoded.

This may be further shown by referring to the previously referenced example. In the previous scenario the decreasing rank order as indicated by the sub band index for the second sub region after reordering is given by

23 17 11 16 13 14 15 12 20 22 21 18 19 10

In this example, the availability of coding bits for the second sub region only allows the first 6 sub bands to be transmitted, that is

23 17 11 16 13 14

In this scenario the following sub band signalling stream may be included in the bit stream in order to indicate the presence of sub bands over the second sub region

0, 1, 0, 1, 1, 0, 1, 1, 0, 0, 0, 0, 0, 1

In this particular example a (‘1’) indicates that the sub band is present, and (‘0’) indicates that the sub band is discarded. It is to be noted that in this example no indication is required for sub-bands 0 to 9 which may be part of the first sub-region. Since the number and selection of sub-bands within the first sub-region is fixed, there in no requirement to send signalling information regarding their selection/distribution as they are automatically included.

The process of generating indicators/side information is shown as step 1013 in FIG. 9.

The first region encoder 407 may then encode the sub-band spectral difference signal according to any suitable difference encoding scheme. For example an intensity side encoding or mid/side encoding process may be used to generate an encoded difference signal. Furthermore the first region encoder 407 may quantize the sub-band spectral difference signals or may quantize the results from the suitable difference encoding scheme. The first region encoder 407 may therefore in a preferred embodiment of the invention perform lattice quantization similar to that applied within embedded variable bit rate encoding.

The encoding of the sub-band spectral difference signal may be shown in FIG. 9 by step 1015.

The second region encoder 411 may also perform further processing on the sub-band divided spectral difference signal, and energy levels for each sub band which are not encoded by the first region encoder 407.

For example in a first embodiment of the invention, the outputs from the sub band divider 405 may be connected to the input of the second region encoder 411.

The second region encoder 411 may in some embodiments of the invention receive, or may be configured to filter from the received spectral coefficients and energy values of sub bands, the spectral coefficients and energy values of sub-bands which were not passed to/or processed by the first region encoder 407.

In one embodiment of the invention, as described previously, the first region encoder is configured to output a feedback signal to the sub-band divider 405, the feedback signal indicating which of the received spectral coefficients and energy values of sub bands to be sent to the second region encoder 411.

In further embodiments of the invention the first region encoder is configured to output a feedback signal to the second region encoder 411, the feedback signal indicates to the second region encoder which of the received spectral coefficients and energy values of sub bands are to be kept and which are to be discarded.

In other embodiments of the invention the division of the regions is such that at least one sub-band difference signal and energy value is passed to both the first region encoder 407 and the second region encoder 411. The first region encoder and the second region encoder are configured so that the duplication in information values passed to each of the region encoders reduces the probability that a sub-band is neither processed by the first region encoder 407 and the second region encoder 411.

Thus the output from the sub band divider 405 may also include spectral coefficients and energy values for sub bands which may have also been passed to the first region encoder 407. These spectral coefficients may be associated with sub-bands which were not encoded by the first region encoder 407. Typically the sub-band energy levels and spectral difference signal coefficients passed to the second region encoder 411 are associated with the higher frequencies of the difference signal.

This filtering of the difference signal coefficients/energy levels is shown in FIG. 9 by step 1003.

The second region encoder 411 orders the indices of the remainder sub-bands in a descending rank order of the energy levels for each sub band. This initial ordering may be carried out to improve the coding efficiency of the second region encoder.

In a preferred embodiment of the invention the sub-band rank order may be based on the root mean square value of the spectral coefficients within the sub-band. The root mean square value may be calculated using the sub-band energy level of the spectral difference signal as provided by the band divider 405. This, for example, may be represented according to the following equation:

$${RMS}_{subband} = \sqrt{\frac{{e}_{D} ( k )}{{offset}_{1} ( k + 1 ) - {offset}_{1} ( k )}}$$

Where e_{D}(k) represents the energy of sub band whose index is k, and offset₁ is the frequency offset table describing the frequency index offsets for each spectral sub-band.

In further embodiments of the present invention different energy measures may be used to represent the energy level of each sub-band, examples may include the mean square and the mean of the absolute values.

The initial ordering of the received difference signal coefficients may be shown in FIG. 9 by step 1017.

In embodiments of the invention, the second region encoder 411 may furthermore implement time masking by incorporating the masking effect of previous frames onto the current frame being processed.

In one such embodiment of the invention the second region encoder 411 implements time based masking by comparing the energy level of a sub band from a previous frame with the energy level of a sub band from the current frame. The frequency range and position within the spectrum of the sub-bands over which the comparison is performed may be the same for both previous and current frames.

If the result of the comparison indicates that the value of the energy level of the sub-band from the previous frame is larger than the energy level of the sub-band from the current frame by a pre-calculated factor, then the second region encoder 409 determines that the previous frame has masked the current frame.

The second region encoder 409 may check for time based masking on a per sub-band basis, spanning all sub-bands within the spectrum of the received difference signal.

This process may be represented as the following pseudo code;

```
for each sub band
{
  aMask[k] = 0;
  /*
  * channel energy of t−1 frame masks the frame t.
  */
if(pastE[1][k] > 4 * pastE[0][k])
    aMask[k] = 1;
  /*
  * channel energy of t−2 frame masks the frame t.
  */
  Else if (pastE[2][k] > 8 * pastE[0][k])
    aMask[k] = 1;
}
```

The parameter pastE is a store of energy values for each spectral band at time instants t-2 (index 2), t-1 (index 1), and t (index 0).

The second region encoder 409 operating the above pseudo code in embodiments of the invention therefore implements time based masking for each sub band. In other words high energy values from the previous two audio frames may be assumed to mask the current frame if the energy difference between frames is above a pre determined threshold.

In the exemplary embodiment of the present invention the effect of frequency based masking in a sub band within the spectral difference signal may be accounted for by considering the accumulative effects of energy spread from neighbouring sub-bands. This may be realised by taking the energy level of a particular sub-band and projecting its masking effect across neighbouring sub-bands. The masking effect of a particular sub-band on neighbouring sub-bands will decrease in proportion to the distance a neighbouring sub band is from the masking source.

In some embodiments of the present invention the masking effect of a sub-band may be modelled as a straight line projected across neighbouring sub-bands in the frequency domain. The slope of the line may be determined such that the masking effect decreases in a liner manner with increasing distance of the masked sub bands from the masking sub-band. The cumulative effect of masking on a particular sub-band may be represented by summing all the levels of projected masking, from neighbouring sub-bands, which lie within the frequency range of the particular sub-band. Frequency based masking for increasing and decreasing sub-bands may be achieved according to the following pseudo code

```
for all sub bands
  eLevels[sb] = 10 * log10(pastE[0][sb]);
  /*
  * Masking slope towards higher frequencies.
  */
  for all sub bands
  {
    for(j = 0; j < sb; j++)
    {
      startLevel = eLevels[j];
      for(k = j; k < sb; k++)
      {
        startLevel −= 4.0;
        if(startLevel < 0)
          startLevel = 0;
      }
      /*-- Subband is masked by other subbands. --*/
      if(startLevel > eLevels[sb])
        aMask[sb] = 1;
    }
  }
  /*
  * Masking slope, towards lower frequencies.
  */
  For all sub bands
  {
    for(j = M − 1; j >= sb; j−−)
    {
      startLevel = eLevels[j];
      for(k = j; k > sb; k−−)
      {
        startLevel −= 6;
        if(startLevel < 0)
          startLevel = 0;
      }
      /*-- Subhead is masked by other subbands. --*/
      if(startLevel > eLevels[sb])
        aMask[sb] = 1;
    }
  }
```

Further, it is to be noted that different masking rules may be utilised depending on if a negative or positive slope of masking is applied. For example a 4 dB slope may be applied for increasing frequencies and a 6 dB slope applied for decreasing frequencies. These values have been experimentally determined to produce an advantageous result.

In a preferred embodiment of the invention, the second region encoder 411 may incorporate the effects of both time and frequency based masking when determining rank order of the sub bands within the received spectral difference signal of the frame being processed. The second region encoder 411 may calculate for each sub-band the contributory effect of time based and frequency based masking to the measured energy level. If the second region encoder 411 determines that this contributory effect is above a pre-determined threshold it may declare that the sub-bands are masked. The masking effect may be incorporated into the process of determining the rank order by “artificially” lowering the sub band energy level of a declared masked sub-band. This may be done before the process of ordering the sub band indices according to the energy level within each sub band has started.

The application of time and frequency masking to the sub-bands is shown in FIG. 9 by step 1019.

The second region encoder 411 may furthermore select a number of sub-bands and reduce the number of sub bands and hence spectral coefficients of the spectral difference signal to be encoded. The second region encoder 411 in some embodiments of the invention may select a second sub-set of sub-bands comprising in order to limit the number of bits required to represent this particular region of the spectrum.

In a first embodiment of the invention, the second region encoder 411 may determine the second sub-set of sub-bands for further processing by considering the relative energy level of each sub band when compared to an adaptive mean value. The adaptive mean value may be calculated by considering all sub-band energies within the spectral difference signal received and processed by the second region encoder 411. This adaptive mean value may be an adaptive threshold whereby the energy level of each sub-band from the ordered list may be compared.

The point at which sub-bands are considered for discarding by the second region encoder may be determined to be the first sub-band index, when traversing the ordered sub-band list starting from the beginning, at which the energy level of the associated sub-band is below the threshold value. At this sub-band index, all sub-bands whose energies are above this threshold value that is all sub-bands whose indices have a higher order in the ordered list may be kept by the second region encoder 411 for further processing.

The second region encoder 411 may discard sub-bands whose energies are below this threshold value (that is all sub-bands whose indices have a lower order in the ordered list).

As indicated previously, the mean threshold value is an adaptive value in the sense that the value will vary from frame to frame according to the energy level profile of the sub-bands within the spectral difference signal.

The second region encoder 411 may furthermore retain the size of the selected second sub-set of sub-bands for further processing, which may also vary from frame to frame.

The second region encoder 411 selection of the second sub-set of sub-bands considered for further processing by the second region encoder may be further explained by way of the following example.

If the ordered list (in rank order of decreasing energy level) of sub-bands within the frequency range of the second region encoder is

ordered set sub-band indices=12 20 22 21 18 19 15 10 23 26 24 25

where the numbers represent the index of each sub-band in the ordered list.

The corresponding energy levels for each of the above sub band indices may be for example determined to be

ordered set sub-band energy values=56 53 45 44 32 31 28 26 7 6 4 2

The mean threshold value in this case may be calculated to be 27.8. In this particular example all sub-bands above this threshold value may be selected by the second region encoder 411 for further processing. All sub bands below this threshold value may be discarded by the second region encoder. Therefore in this particular example the sub-set for further processing may comprise the following sub-bands, in decreasing rank order.

selected second sub-set sub-band indices=12 20 22 21 18 19 15

The second region encoder 411 may determine in a first embodiment of the invention the mean threshold value to be the mean energy value of all sub-bands which are passed to the second region encoder.

In a further embodiment of the invention the second region encoder 411 may determine the mean threshold value to be the variance removed mean energy value of all sub-bands passed to the second region encoder. The variance removed mean energy value of all sub-bands passed to the second region encoder 411 in the further embodiments of the invention may be expressed as mean−var

The variance or spread of the mean value may be given by the following expression

$$var = \frac{1}{K} {\sum }_{i = 0}^{K - 1} \vert rmsValue [ i ] - mean \vert$$

In further embodiments of the present invention, the mean energy value of all sub bands may be the mean of the RMS values. This value may be expressed as

$$mean = \frac{1}{K} {\sum }_{i = 0}^{K - 1} rmsValue [ i ]$$

Where K is the number of sub bands passed into the second region encoder and rmsValue is the RMS energy value of each of the sub bands which may be produced in the sub-band divider 405 as discussed above.

In embodiments of the invention, the second region encoder 411 determines which of the values of mean threshold used on the basis of the variance or spread of the mean value.

If the mean value is large compared to the spread or variance of the mean value, then the second region encoder 411 uses the variance removed sub-band mean as the mean threshold value. If, however, the mean value is relatively low compared to the variance or spread the second region encoder 411 uses the mean energy value of all sub-bands which are passed to the second region encoder for the threshold value. This second situation is analogous to the probably density function of the RMS values consisting of a large standard deviation.

The process of selecting the number of sub-bands to be encoded by the second region encoder 411 may be implemented in a preferred embodiment as described above according to the following section of pseudo code

| for(each sub band received by the second region encoder, k++) | | |
|---|---|---|
| { | | |
| if(ss == 0) | | |
| ratio0 = mean − var; | | |
| else | | |
| ratio0 = mean; | | |
| ratio1 = rmsValue[k]; | | |
| if(ratio1 < ratio0) | | |
| { | | |
| frameSb = k + 1; /* sub band index limit */ | | |
| exit for-loop; | | |
| } | | |
| } | | |
| | | 1, 0.5·mean < var |
| ss = | {open oversize brace} | |
| | | 0, otherwise |

The parameter frameSb is the sub-band index limit for the sub bands which may be encoded in the second region encoder.

The process of selecting the second sub-set of sub-bands to reduce the encoding requirements is shown in FIG. 9 by step 1021.

The second region encoder 411 may further divide the selected spectral difference signal into at least two further sub-regions, which for example may be called sub-regions 2A and 2B. The first sub-region (2A) of the second region may consist of higher energy sub-bands as determined from the previous ordering process. These higher energy sub-bands are determined to be of a higher level of perceptual importance.

The second sub-region (2B) of the second region encoder 409 may comprise sub-bands whose energy levels are lower than those of the second region first sub-region 2A, as also determined by the previous ordering process.

The number of sub-bands allocated to each sub-region may be variable, and at least partly dependent on the statistical characteristics of the ordered list of sub-bands.

The second region encoder in some embodiments of the invention divides the sub-bands of the first sub-region and the sub-bands of the second sub-region by considering the normalised energy level of each sub-band when compared to an energy threshold value. The division of sub-bands between the first sub-region and second sub-region may be the first sub-band index, when traversing the ordered sub-band list starting from the beginning, at which the normalised energy level of the associated sub-band is below the energy threshold value. At this sub-band index, all sub-bands whose normalised energies are above this threshold value (in other words all sub bands whose indices have a higher order in the ordered list) may be assigned to the first sub-region. All sub bands whose normalised energies are below this threshold value (in other words all sub-bands whose indices have a lower order in the ordered list) may be assigned to the second sub-region.

In further embodiments of the invention the threshold criterion may be dependent on a decrease in energy levels when traversing from one sub-band energy value to the next.

In a preferred embodiment of the invention the energy threshold may be derived from a normalised energy value which represents the total energy of all the remaining sub-bands. The total normalised energy value may be configured to have a numerical range from zero to one, whereby the value of one may represent the total energy of all the remaining sub-bands. The threshold value may be pre-determined to be a fraction of this normalised energy value. The normalised energy contribution from each sub-band may be calculated by normalising the energy within the sub-band by an energy value representing the total energy of all sub-bands.

The division of the frequency range may then be determined by accumulating the normalised energy levels when traversing from one sub-band to the next in rank order, starting from the sub-band with the highest energy level. At the end of each traverse the accumulated normalised energy level may be checked against the threshold in order to determine if the threshold has been exceeded.

The sub-bands within the frequency range may then be divided into the at least two sub-regions. The first sub-region may comprise the sub-bands above the threshold value and the second sub-region may comprise the sub-bands below the threshold value.

In the preferred embodiment of the invention the normalised energy of each remaining sub-band may be expressed as:

r[i]=rmsValue[i]/(mean.K)

Where rmsValue is the root mean square energy value for each remaining sub-band, mean is the mean energy value of all remaining sub-bands in the spectral difference signal received by the second region encoder, and K is the total number of remaining sub bands within the spectral difference signal.

The division of the remaining sub-bands into at least two sub-regions is shown in FIG. 9 by step 1023.

The second region encoder 411 may further determine the number of bits which may be used for encoding the spectral coefficients for both second region sub-regions dependent on a combination of factors. These factors may include the total number of bits allocated to the second region encoder, the number of sub-bands and hence the number of spectral components within each sub-region and the number of bits required to encode side information for each sub-region.

As indicated previously the second region encoder 411 may divide the sub-bands into those in a first sub-region (2A) and those in a second sub-region (2B) dependent on the sub-band normalised energy level being either greater than, or less than, a specified fraction of the normalised energy of the remaining sub-bands. The first sub-region (2A) may comprise spectral components whose energy levels are higher than those allocated to the second sub-region (2B).

The second region encoder 411 may prioritise the quantization of first sub-region (2A) spectral coefficients over the quantization of second sub-region (2B) spectral coefficients. This prioritisation may take the form of allocating a sufficient number of bits to encode and quantize all spectral coefficients within the first sub region, whilst only encoding and quantizing a selection or sub-set of the spectral coefficients assigned to the second sub-region 2B. The number of second sub-region sub-bands (and hence spectral coefficients) which may be quantized may depend on the remaining number of bits after determining the number of bits used in the quantization of the first sub region.

The second region encoder 411 may determine the number of bits required by in order to encode and quantize the first sub-region's spectral coefficients based on the consideration to balance the need to reserve bits for quantising the second sub region's spectral coefficients.

In a first embodiment of the invention the second region encoder 411 may determine the number of bits required to encode and quantize the first sub-region from:

$$firstsubregion\_bits = MIN ( \begin{matrix}firstsubregion\_coeffs , \\ \frac{bitsAvailable - sideBits}{Q}\end{matrix} )$$

Where the parameter bitsAvailable represents the total number of bits available to the second region encoder 411, the parameter sideBits represents the number of bits required to transmit the encoded sub-band indices for both the second region first and second sub-regions, and MIN returns the minimum of the two values. The number of first sub-region coefficients is given by

$$firstsubregion\_coeffs = {\sum }_{subbandIndex = 0}^{splitSb - 1} {offset}_{1} [ subbandIndex + 1 ] - {offset}_{1} [ SubbandIndex ]$$

Where the parameter splitSB is the index value in the ordered list of remaining sub-band indices at which the sub-bands are divided into a first and second sub-regions.

In other words the second region encoder 411 in an embodiment of the invention may determine the number of bits required by the first sub region to be the minimum value of a parameter which represents the number of spectral coefficients within the first sub-region 2A, and a parameter which represents a possible number of bits which may be used by the first sub region in order to quantize the spectral coefficients divided by a predetermined factor Q.

The predetermined factor Q in the above expression may in embodiments of the invention be 2. This factor is determined experimentally in order to balance the requirement of coding all coefficients within the first sub-region 2A, with the need to have sufficient bits in order to represent at least the more important spectral coefficients in the second sub-region 2B. In further embodiments of the invention different values for the factor Q may be chosen.

As indicated in the previous section the determination and selection of a number of spectral coefficients, and therefore the number of spectral sub-bands, within the second sub-region 2B may be generated from calculating the number of second sub-region bits available for coding and quantization.

The second region encoder may calculate the number of spectral coefficients which may be coded and quantized for the second sub-region 2B and furthermore calculate the number sub-bands which may be coded and quantized by a process of mapping the number of calculated spectral coefficients to the accumulated sum of the widths of each sub-band.

In a first embodiment of the invention the second region encoder 411 determines the number of bits required to encode and quantize the second sub-region 2B as the difference between the total number of bits available for the whole second region and the number of bits pre-allocated for the first sub-region 2A and side information. This may be expressed as

secondsubregion_bits=bitsAvailable−(firstsubregion_bits+sideBits)

The second region encoder 411 may then determine the number of second sub-region coefficients as

$$sendsubregion\_bins = \{ \begin{matrix}2 \cdot sendsubregion\_bits , & binLimit > 2 \cdot sendregion\_bits \\ binLimit , & otherwise\end{matrix} \\ binLimit = MAX ( \begin{matrix}96 - firstsubreion\_bins , \\ {\sum }_{i = splitSb}^{frameSb - 1} {offset}_{1} [ subbandIndex + 1 ] - {offset}_{1} [ subbandIndex ]\end{matrix} )$$

The number of second sub-region coefficients may be limited by the value of binLimit. In other words the number of spectral coefficients in the second sub-region may not exceed a maximum between a minimum spectral coefficients present and the sum of the number of possible spectral coefficients present in the sub-bands within the second sub-region.

The value ‘96’ in this first embodiment of the invention is the number of spectral coefficients within the frequency range of the spectral difference signal received by the second region encoder. However, it is to be understood that further embodiments may use different values which may vary in accordance with the frequency range and sampling rate of the signal received by the second region encoder 411.

Furthermore other embodiments of the invention may limit the number of second sub-region sub-bands to be encoded. For example, an embodiment of the invention using a frequency range comprising 96 spectral coefficients may limit the maximum number encoded sub-bands in the second sub-region to be 6.

The determination of the number of bits required for coding and quantizing the sub-regions 2A and 2B is shown in FIG. 9 in step 1025.

The second region encoder 411 may then side-information encode the indices of the sub-bands selected for the first sub-region 2A.

In embodiments of the invention, side-information encoding of the first sub-region 2A sub-band indices may take the form of assigning a single bit associated with each one of the sub-band indices retained by the second region encoder 411. The state of the bit may then be used to indicate if the associated sub-band is part of the first sub-region 2A.

This may be further explained by considering the following example. If the second region encoder 411 receives a spectral difference signal whose sub bands range from sub-band index 7 to sub-band index 20, and the second region encoder 411 selects a first sub-region 2A of the sub bands 10, 11, 14, 15 and 17, the second region encoder may have the following bit sequence.

| | Band # | | | | | | | | | | | | | |
|---|---|---|---|---|---|---|---|---|---|---|---|---|---|---|
| | 7 | 8 | 9 | 10 | 11 | 12 | 13 | 14 | 15 | 16 | 17 | 18 | 19 | 20 |
| Signalling bit/First sub region | 0 | 0 | 0 | 1 | 1 | 0 | 0 | 1 | 1 | 0 | 1 | 0 | 0 | 0 |

In further embodiments of the invention the second region encoder 411 may compare the pattern of encoding sub-band indices for a first sub-region in the current frame with the pattern of encoding for the same first sub-region for a previous frame to generate a differential side-information encoding scheme. For example the second region encoder 411 may carry out a comparison to determine if both frames comprise the same encoded sequence of sub-band indices and if both frames comprise the same encoded sequence no encoded sequence of sub band indices for the first sub-region are distributed, or a simple code is used to indicate this is the situation.

The second region encoder 411 may implement this scheme by inserting an extra signalling bit representing a ‘match’ between the previous and current frames into the bit stream on a frame by frame basis.

The second region encoder 409 may encode the indices of the sub bands selected for the second sub region.

The second region encoder 411 may then encode the side-information for the second region second sub-region 2B. In other words the second region encoder 411 generates a series of indicators which enable a decoder to determine the distribution of the sub-set of sub-bands that have been selected from the second sub-region for encoding.

In a first embodiment of the invention the second region encoder 411 may associate a single bit to each sub-band position index, where the state of the bit indicates if the associated sub-band is part of the selected second sub-region.

Further embodiments of the invention may also incorporate information about the side information coding indicating the distribution of sub-bands within the first sub-region 2A. This information may be used to reduce the number of bits required to indicate the sub-band distribution of the second sub-region 2B. For example the second region encoder 411 may only provide side-information for those sub-bands not included in the first sub-region 2A.

This embodiment of the invention may be further explained by considering the previously presented example. The second region encoder 411 received a spectral difference signal whose sub-bands ranged from the sub band index 7 to the sub band index 20. The second region encoder 411 selects a first sub-region of the sub bands 10, 11, 14, 15 and 17 (as shown previously), and a second sub region of the sub bands 8, 9, 12 and 13.

The second region encoder may, to avoid duplication of information, omit sending any indicators/information linked to the distribution of second region first sub-region sub-bands 2A and may generate the following bit sequence.

| | Band # | | | | | | | | | | | | | |
|---|---|---|---|---|---|---|---|---|---|---|---|---|---|---|
| | 7 | 8 | 9 | 10 | 11 | 12 | 13 | 14 | 15 | 16 | 17 | 18 | 19 | 20 |
| Signalling bit/Second sub region | 0 | 1 | 1 | — | — | 1 | 1 | — | — | 0 | — | 0 | 0 | 0 |

Is to be understood that in some embodiments of the invention the side information may be generated in a single pass and/or the first sub-region 2A and second sub-region 2B information combined into one side information stream.

The encoding of the side information for the first sub-region 2A and second sub-region 2B can be shown in FIG. 9 by step 1027.

The second region encoder 411 may then encode and quantize the spectral difference samples within the selected sub-bands from the first sub-region 2A and second sub-region 2B.

In a preferred embodiment of the invention the second region encoder 411 normalises of the sub band spectral values by applying the following:

```
for(k = 0, i = 0; k < varEnd; k++)
{
  if(bandsToInclude[k])
    for(j = offset₁(k); j < offset₁(k+1); j++)
      normspec[i++]=sgn(D_{f}(j))·|D_{f}(j)|^{3/4};
}
```

Where sgn( ) returns the sign of the specified sample and bandsToInclude indicates the sub-bands which are to be encoded and quantized. Quantization of the normalised spectral samples may take the form of multi-rate lattice vector based quantisation such as that used in the international telecommunication union EV-VBR baseline codec. Details of this quantization scheme may be found in U.S. Pat. No. 7,106,228. However, it is to be understood that further embodiments of the invention may deploy different quantization schemes, non limiting examples may include codebook vector quantisation or Lloyd-Max scalar quantization,

The process of encoding/quantizing the spectral difference coefficients is shown as step 1029 in FIG. 9.

The second region encoder 411 outputs the encoded second region difference values and the side information to the multiplexer 413. Similarly the first region encoder 407 outputs the encoded first region difference values and side information to the multiplexer.

The multiplexer generates a single bitstream from the first and second region encoder bitstreams and outputs the single bitstream on the output to be received by the bitstream formatter 280.

It is to be understood that the above examples have been included to clarify the understanding of the invention, and should not be interpreted as limiting features. Further, the number of sub-bands should not be interpreted in light of the above utilised examples. The invention may be implemented using a different number sub-bands and accordingly a different distribution of sub-bands to the first and second regions/frequency portions. Furthermore, some embodiments of the invention may represent the whole frequency spectrum of the difference signal as a first region/frequency portion signal, and therefore all the sub-bands within the signal will be encoded. Further still, other embodiments of the invention may represent the whole frequency spectrum of the difference signal as a second region/frequency portion signal. In this case all the sub-bands will be subjected to the ordering and selecting process in order to determine a sub-set of sub-bands for distribution to the bit stream.

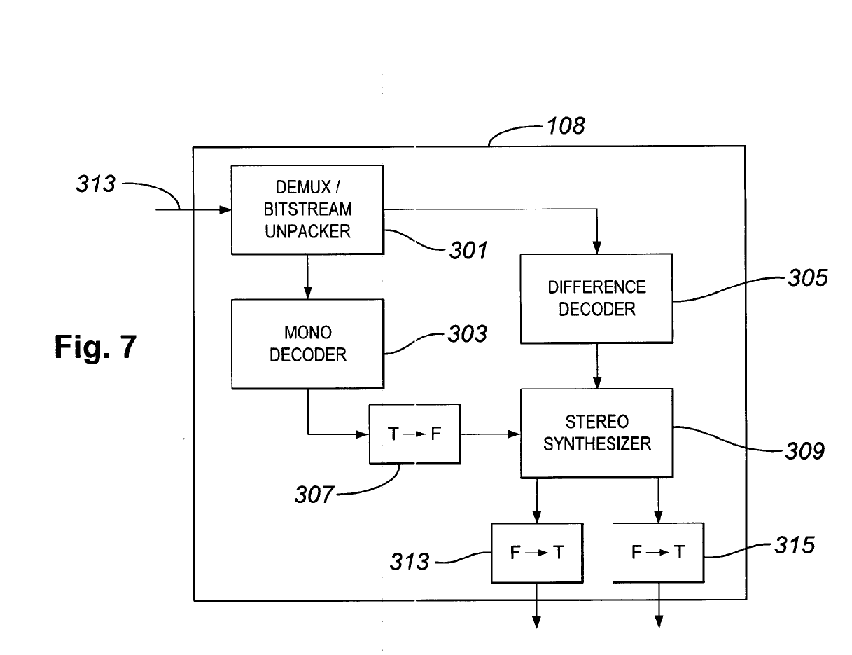

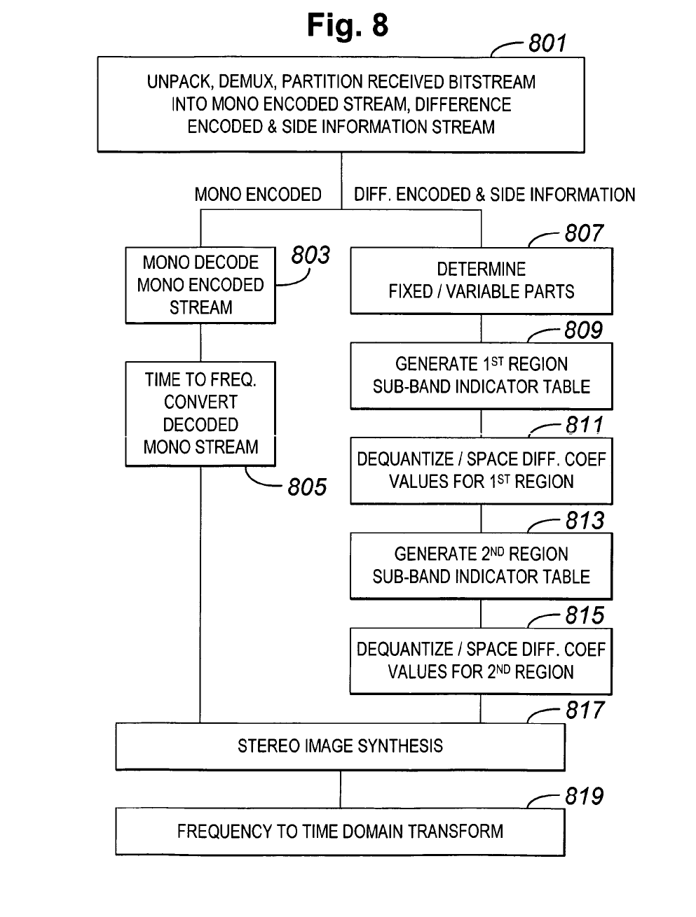

To further assist the understanding of the invention the operation of the decoder 108 with respect to the embodiments of the invention is shown with respect to the decoder schematically shown in FIG. 7 and the flow chart showing the operation of the decoder in FIG. 8.

The decoder comprises an input 313 from which the encoded bitstream 112 may be received. The input 313 is connected to the bitstream unpacker 301.

The bitstream unpacker is configured to demultiplex, partition, or unpack the encoded bitstream 112 into at least two separate bitstreams. The mono encoded audio bitstream is passed to the mono audio decoder 303, the encoded difference spectral values and the side information is passed to the difference decoder 305.

This unpacking process is shown in FIG. 8 by step 801.

The mono decoder 303 receives the mono audio encoded data from the bitstream unpacker 301 and constructs a synthesised single channel audio signal by performing the inverse process to that performed in the mono audio encoder 230. This may be performed on a frame by frame basis. In a first embodiment of the invention the output from the mono decoder 303 is a time domain based signal.

This mono decoding process of the encoded mono audio signal is shown in FIG. 8 by step 803.

The time to frequency domain converter 307 receives the time domain mono channel synthesized signal from the mono decoder 303 and then converts the mono channel synthesized signal into a frequency domain based representation using a time to frequency transformation. In a preferred embodiment of the invention the time to frequency transformation may be a modified discrete cosine transform (MDCT).

It is to be understood that in other embodiments of the invention, the time to frequency domain transformation may stereo synthesis may be performed in other frequency domain representations of the signal, which are obtained as a result of a discrete orthogonal transform. A list of non limiting examples of the transform that may be used in the time to frequency domain transformer 307 may include a discrete fourier transform, a discrete cosine transform, and a discrete sine transform. The time to frequency domain transform may in some embodiments be chosen to match the same frequency domain representation used in the encoder 104 to convert the left and right channel audio signal from the time domain to the frequency domain in order to carry out difference analysis on the signal.

In some embodiments of the invention where the output from the mono audio decoder 303 is a frequency domain representation of the synthesized signal, the time to frequency domain transformer 307 may be omitted or bypassed. In other embodiments of the invention the mono audio decoder 303 may incorporate the operation of the time to frequency domain transformer 307 and therefore no separate time to frequency domain transformer 307 is required. The output from the time to frequency domain transformer 307 may then be connected to the stereo synthesiser 309.

The time to frequency conversion of the decoded mono signal is shown in FIG. 8 by step 803.

The difference decoder 305 is configured to receive the encoded difference spectral coefficient values and the side-information.

The difference decoder 305 is configured to determine the fixed, in other words the encoded first region first sub-region 1A sub-bands, and the variable, in other words the encoded first region second sub-region 1B and second region 2A, 2B parts. This may be determined from a received indicator value or may be determined by using a process similar to the process carried out in the first region encoder to allocate bits to the first and second sub-regions for the first region sub-bands as shown in FIG. 9 step 1005.

This determination of the fixed/variable parts is shown in FIG. 8 by step 807.

The difference decoder 305 on determining the fixed/variable boundary reads the side-information data. In a first embodiment of the invention there may also be implemented a side-information insertion operation which inserts into the side-information data information on the fixed sub-bands.

For example the following pseudocode, when performed would create a table bandsToInclude_decoder[0 . . . #Sub_bands] which would provide an ‘1’ where the decoder is to decode the sub-band and a ‘0’ where the decoder is not to decode the sub-band (as there is no encoded sub-band information). The pseudocode performs a first part where ‘1’ values are inserted for all of the fixed sub-bands designated by the variable fixedBands and then a second part where the bitstream values are used to insert the ‘1’ values.

```
for(k = 0; k < fixedBands; k++)
  bandsToInclude_decoder[k] = bit ‘1’;
for(k = fixedBands; k < varEnd; k++)
  bandsToInclude_decoder[k] = “read 1 bit from bitstream”;
```

The difference decoder 305 having generated a list of the index values for the sub-bands for which there is encoded difference spectral information then reads or extracts the spectral samples and performs a complementary decoding and dequantization operation to that performed in the first region encoder 407 (as described above with respect to the step 1015 of FIG. 9) on the determined spectral samples. Furthermore the difference decoder 305 is configured in some embodiments of the invention to insert null values where no encoding of the difference value was carried out and therefore place the samples in correct order spacings. This may be carried out by the difference decoder 305 in a preferred embodiment of the invention by the following pseudocode, which generates a dequantized or null value for each difference frequency value D_{f}_{_{—}}_{dec}(j) for all j values.

```
for(k = 0, i = 0; k < varEnd; k++)
{
  if(bandsToInclude_decoder[k] = bit ‘1’)
  {
    for(j = offset₁(k); j < offset₁(k+1); j++, i++)
      D_{f}_{_{—}}_{dec}(j) = sgn(qSpec[i])·|qSpec[i]^{4/3};
  }
  else
  {
    for(j = offset₁(k); j < offset₁(k+1); j++)
      D_{f} _{_{—}}_{dec}(j) = 0;
  }
}
```

This dequantization, decoding and spacing of coefficients for the first region is shown in step 811 of FIG. 8.

The difference decoder furthermore reads the side information generated by the second region encoder 411 to determine the encoded difference spectral values encoded. The difference decoder 305 may in embodiments of the invention generate a table of values which represent which of the second region sub-bands are available for decoding.

The difference decoder 305 may generate the table in an embodiment of the invention by firstly reading the side information relating to the first sub-region 2A of the second region and then reading the side information relating to the second sub-region 2B of the second region. By reading the side information in this way it is possible for the reader to decode the side information where for example the redundant side-bands were removed from coding the second region second sub-region side band indicators.

The difference decoder 305 may thus implement the decoding of the side information by using the following parts of pseudocode which not only uses redundancy removal from the first to second sub-region but also uses differential coding of the side information—in other words uses the information from previous frames. Firstly the reading of the second region first sub-region information.

```
if(“read 1 bit from bitstream” == bit ‘1’)
{
  for(k = 0; k < K; k++)
    region2_flag[k] = region2_flag_prev[k];
}
else
  for(k = 0; k < K; k++)
    region2_flag[k] = “read 1 bit from bitstream”;
```

and the reading of the second region second sub-region, also called the region 3 in the following pseudocode.

```
for(k = 0; k < K; k++)
{
  region3_flag[k] = 0;
  if(region2_flag[k] == 0)
    region3_flag[k] = “read 1 bit from bitstream”;
}
```

where the region2_flag_prev (which is initialized at startup) holds the side information/signalling bits of the previous frame.

The generation of the second region sub-band indicator table is shown in step 813 of FIG. 8.

The difference decoder 305 furthermore then decodes, dequantizes and places the decoded dequantized spectral difference values in the correct spectral location in a manner to complement the encoding, quantizing and compression processes carried out within the second region encoder. For example the number of bits used to quantize the first and second sub-regions of the second region may be derived using the same method employed to determine the number of bits in the second region encoder 411.

The difference decoder 305 may in an embodiment of the invention operate the following pseudocode to extract and place the difference spectral values:

```
for(k = 0, i = 0; k < K; k++)
{
  if(region2_flag[k] == bit ‘1’)
  {
    for(j = offset₁(k); j < offset₁(k+1); j++, i++)
      D_{f}_{_{—}}_{dec}(j) = sgn(gSpec[i])·|qSpec[i]^{4/3};
  }
  else
  {
    for(j = offset₁(k); j < offset₁(k+1); j++)
      D_{f}_{_{—}}_{dec}(j) = 0;
  }
}
```

which extracts and places the difference spectral values in the second region first sub-region B1 as described in the code by the region2_flag[k] values.

```
for(k = 0, i = 0; k < K; k++)
{
  if(region3_flag[k] == bit ‘1’)
  {
    for (j = offset₁(k); j < offset₁(k+1); j++, i++)
      D_{f}_{_{—}}_{dec}(j) = sgn(qSpec[i])·|qSpec[i]^{4/3};
  }
  else
  {
    for(j = offset₁(k); j < offset₁(k+1); j++)
      D_{f}_{_{—}}_{dec}(j) = 0;
  }
}
```

which and places the difference spectral values in the second region second sub-region B2 as described in the code by the region3_flag[k] values.

The decoding/dequantization/placing of the second region difference spectral values may be seen in FIG. 8 in step 815.

The difference decoder 305 outputs the decoded and placed difference spectral values to the stereo synthesizer 309.

The stereo synthesizer 309 having received the spectral representation of the mono decoded signal from the time to frequency domain transformer 307 (or in some embodiments from the mono decoder 303 directly), and the difference spectral representations from the difference decoder 305, generates a frequency domain representation of the two channel signals (left and right) for each sub band. In the exemplary embodiment of the invention this may be achieved according to the following pseudo code:

```
for(k = 0; k < M; k++)
{
  for(j = offset₁[k]; j < offset₁[k+1]; j++)
  {
    R_{f}(j)=M_{f}(j)+D_{f}_{_{—}}_{dec}(j)
    L_{f}(j)=R_{f}(j)−D_{f}_{_{—}}_{dec}(j)
  }
}
```

where the L_{f} and R_{f} are the frequency domain representations of the synthesised left and right channels, respectively.

The process of synthesising the two channels of the audio signal is shown as step 817, in FIG. 8.

In the embodiment shown above the difference decoding was the complimentary to a mid/side based encoding operation carried out in the region encoder. It would be appreciated that an intensity stereo based encoding process carried out on the left and right channel frequency coefficients may be complemented by a similar intensity stereo decoding process.

Furthermore the stereo synthesizer 309 is configured in further embodiments of the invention to perform the complementary decoding to the difference encoding process performed in the difference signal calculator 260, where the difference encoding is not a mid/side or intensity stereo encoding operation.

The generation of the synthesized frequency domain representations of the stereo channel signals is shown in FIG. 8 by step 817.

Once the left and right channels have been synthesised, they may be transformed into two time domain channels by performing the inverse of the unitary transform used to transform the signal into the frequency domain. In the exemplary embodiment of the invention this may take the form of an inverse modified discrete transform (IMDCT) as depicted by stages 313 and 315 in FIG. 7.

The process of transforming the two channels (stereo channel pair) is shown as step 819, in FIG. 8.

It is to be understood that even though the present invention has been exemplary described in terms of a stereo channel pair, it is to be understood that the present invention may be applied to further channel combinations. For example the present invention may be applied to a two individual channel audio signal. Further, the present invention may also be applied to multi channel audio signal which comprises combinations of channel pairs such as the ITU-R five channel loudspeaker configuration known as 3/2-stereo. Details of this multi channel configuration can be found in the International Telecommunications Union standard R recommendation 775. The present invention may then be used to encode each member pair of the multi channel configuration.

The embodiments of the invention described above describe the codec in terms of separate encoders 104 and decoders 108 apparatus in order to assist the understanding of the processes involved. However, it would be appreciated that the apparatus, structures and operations may be implemented as a single encoder-decoder apparatus/structure/operation. Furthermore in some embodiments of the invention the coder and decoder may share some/or all common elements.

Although the above examples describe embodiments of the invention operating within a codec within an electronic device 610, it would be appreciated that the invention as described below may be implemented as part of any variable rate/adaptive rate audio (or speech) codec. Thus, for example, embodiments of the invention may be implemented in an audio codec which may implement audio coding over fixed or wired communication paths.

Thus user equipment may comprise an audio codec such as those described in embodiments of the invention above.

It shall be appreciated that the term user equipment is intended to cover any suitable type of wireless user equipment, such as mobile telephones, portable data processing devices or portable web browsers.

Furthermore elements of a public land mobile network (PLMN) may also comprise audio codecs as described above.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

For example the embodiments of the invention may be implemented as a chipset, in other words a series of integrated circuits communicating among each other. The chipset may comprise microprocessors arranged to run code, application specific integrated circuits (ASICs), or programmable digital signal processors for performing the operations described above.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs) and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

1-49. (canceled)

50. An apparatus comprising at least one processor and at least one memory including computer program code the at least one memory and the computer program code configured to, with the at least one processor, cause the apparatus at least to:
generate an audio difference signal based at least in part on at least two channels of the audio signal, wherein the audio difference signal comprises at least two parts;
encode at least one part of the audio difference signal to produce a second audio difference signal;
generate at least one indicator, wherein each indicator identifies the at least one part of the audio difference signal;
calculate an energy value for each one of the parts of the audio difference signal; and.
select the at least one part of the audio difference signal based at least in part on the energy value for each one of the parts for the audio difference signal.

51. The as claimed in claim 50, wherein the at least one memory and the computer program code are further configured to, with the at least one processor, cause the apparatus at least to:
select at least one currently unencoded part of the difference signal;
encode the selected at least one currently unencoded part of the difference signal to generate a third audio difference signal;
generate at least one further indicator based at least in part on the at least one indicator, wherein each further indicator identifies the at least one selected unencoded part.

52. The apparatus as claimed in claim 51, wherein the at least one indicator comprises at least one indicator bit associated with an index value of the at least one part of the audio difference signal, wherein each indicator bit has a first value when the at least one part of the audio difference signal is encoded to produce a second difference signal, and a second value when the at least one part of the audio difference signal is not encoded to produce a second difference signal.

53. The apparatus as claimed in claim 52, wherein the at least one further indicator comprises at least one further indicator bit associated with the index value of the at least one part of the difference signal, wherein each further indicator bit has a first value when the at least one part of the audio difference signal is encoded to produce a third difference signal, and a second value when the at least one part of the audio difference signal is not encoded to produce a third difference signal.

54. The apparatus as claimed in claim 53, wherein the at least one memory and the computer program code are further configured to, with the at least one processor, cause the apparatus at least to:
remove any further indicator bits associated with any parts when the at least one part of the audio difference signal is encoded to produce a second difference signal.

55. The apparatus as claimed in claims 51, wherein the at least one memory and the computer program code are further configured to, with the at least one processor, cause the apparatus at least to:
differentially generate at least one of the at least one indicator and the at least one further indicator.

56. The apparatus as claimed in claim 50 wherein the at least one memory and the computer program code are further configured to, with the at least one processor, cause the apparatus at least to:
select the at least one part of the audio difference signal based at least in part on at least one frequency value associated with the audio difference signal part.

57. The apparatus as claimed in claim 51, wherein the at least one memory and the computer program code are further configured to, with the at least one processor, cause the apparatus at least to:
select at least one part of the difference signal based at least in part on at least one frequency value associated with the audio difference signal part;
encode the selected at least one part of the difference signal based at least in part on at least one frequency value associated with the audio difference signal part to generate a fourth audio difference signal;
encode the selected at least one part of the difference signal based at least in part on at least one frequency value associated with the audio difference signal part and to encode at least one part of the audio difference signal to produce a second audio difference signal in a first encoder; and
encode the selected at least one currently unencoded part of the difference signal to generate a third audio difference signal.

58. An apparatus comprising at least one processor and at least one memory including computer program code the at least one memory and the computer program code configured to, with the at least one processor, cause the apparatus at least to:
receive an encoded signal comprising a difference signal part and an difference signal selection part wherein the difference signal selection part comprises a first difference signal selection section and a second difference signal selection section;
decode from the difference signal part based at least in part on the first difference signal selection section a first part of the at least one difference signal component; and
decode from the difference signal part based at least in part on the second difference signal selection section a second part of the at least one difference signal component.
generate at least two channels of audio signals based at least in part on the at least one difference signal component.

59. The apparatus as claimed in claim 58, wherein the encoded signal further comprises a frequency limited difference signal part, and wherein the at least one memory and the computer program code are further configured to, with the at least one processor, cause the apparatus at least to:
decode from the frequency limited difference signal part at least one further difference signal component.

60. The apparatus for decoding an encoded audio signal as claimed in claim 59, wherein the encoded signal further comprises a single channel signal part, and wherein the at least one memory and the computer program code are further configured to, with the at least one processor, cause the apparatus at least to:
decode the single channel signal part to produce at least one single channel signal component, and
generate at least one component of the first channel of the at least two channels of audio signals by summing the at least one difference signal component with the at least one single channel signal component.

61. A method comprising:
generating an audio difference signal based at least in part on at least two channels of the audio signal, wherein the audio difference signal comprises at least two parts;
encoding at least one part of the audio difference signal to produce a second audio difference signal;
generating at least one indicator, wherein each indicator identifies the at least one part of the audio difference signal;
calculating an energy value for each one of the parts of the audio difference signal; and.
selecting the at least one part of the audio difference signal based at least in part on the energy value for each one of the parts for the audio difference signal.

62. The method as claimed in claim 61, further comprising:
selecting at least one currently unencoded part of the difference signal;
encoding the selected at least one currently unencoded part of the difference signal to generate a third audio difference signal;
generating at least one further indicator based at least in part on the at least one indicator, wherein each further indicator identifies the at least one selected unencoded part.

63. The method as claimed in claim 62, wherein the at least one indicator comprises at least one indicator bit associated with an index value of the at least one part of the audio difference signal, wherein each indicator bit has a first value when the at least one part of the audio difference signal is encoded to produce a second difference signal, and a second value when the at least one part of the audio difference signal is not encoded to produce a second difference signal.

64. The method as claimed in claim 63, wherein the at least one further indicator comprises at least one further indicator bit associated with the index value of the at least one part of the difference signal, wherein each further indicator bit has a first value when the at least one part of the audio difference signal is encoded to produce a third difference signal, and a second value when the at least one part of the audio difference signal is not encoded to produce a third difference signal.

65. The method as claimed in claim 64, further comprising removing any further indicator bits associated with any parts when the at least one part of the audio difference signal is encoded to produce a second difference signal.

66. The method as claimed in claim 62 further comprising differentially generating at least one of the at least one indicator and the at least one further indicator.

67. The method as claimed in claim 61 further comprising selecting the at least one part of the audio difference signal based at least in part on at least one frequency value associated with the audio difference signal part.

68. The as claimed in claim 62, further comprising:
selecting at least one part of the difference signal based at least in part on at least one frequency value associated with the audio difference signal part;
encoding the selected at least one part of the difference signal based at least in part on at least one frequency value associated with the audio difference signal part to generate a fourth audio difference signal;
encoding the selected at least one part of the difference signal based at least in part on at least one frequency value associated with the audio difference signal part and to encode at least one part of the audio difference signal to produce a second audio difference signal in a first encoder; and
encoding the selected at least one currently unencoded part of the difference signal to generate a third audio difference signal.

69. A method, comprising:
receiving an encoded signal comprising a difference signal part and an difference signal selection part, wherein the difference signal selection part comprises a first difference signal selection section and a second difference signal selection section;
decoding from the difference signal part based at least in part on the first difference signal selection section a first part of the at least one difference signal component;
decoding from the difference signal part based at least in part on the second difference signal selection section a second part of the at least one difference signal component; and
generating at least two channels of audio signals based at least in part on the at least one difference signal component.

70. The method as claimed in claim 69, wherein the encoded signal further comprises a frequency limited difference signal part and the method further comprises:
decoding from the frequency limited difference signal part at least one further difference signal component.

71. The method as claimed in claim 70, wherein the encoded signal further comprises a single channel signal part, and the method further comprises:
decoding the single channel signal part to produce at least one single channel signal component, and
generating at least one component of the first channel of the at least two channels of audio signals by summing the at least one difference signal component with the at least one single channel signal component.
